(19) United States
(12) Patent Application Publication
(10) Pub. No.: US 2002/0194589 A1
(43) Pub. Date: Dec. 19, 2002

(54) Technique for optimizing the delivery of advertisements and other programming segments by making bandwidth tradeoffs

(76) Inventors: Michael Cristofalo, Doylestown, PA (US); Patrick M. Sheehan, Jamison, PA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/852,229

(22) Filed: May 8, 2001

(51) Int. Cl. H04N 7/173; H04N 7/10

(52) U.S. Cl. 725/32; 725/35; 725/114; 725/116

(57) ABSTRACT

A technique for optimizing the delivery of a multiplicity of advertisements and other programming is provided by trading off full-motion video for other forms of high quality still images, text, graphics and audio. By creating a group of synchronized digital programming components, for example, still-frame video, audio, graphics, text, animation, and media objects, which combined utilize less bandwidth than a standard digital programming segment of full-motion video with CD quality audio, a greater number of differentiable programming content options can be made available in the digital transmission stream. Because of the greatly expanded amount of differentiable content that can be created using the bandwidth tradeoff techniques, greater precision in targeting particular content, such as advertisements, to particular users is possible. The invention also contemplates the system requirements, both hardware and software, for a digital programming transmission center and for a user's receiver, necessary to implement the bandwidth tradeoff methodology.

### FIELD OF THE INVENTION

This invention relates generally to the provision of programming content via digital signals to viewers. Additional bandwidth for advertisements or other programming is leveraged by trading-off standard, full-motion, thirty frame-per-second video for combinations of still-frame video, high quality audio, and graphics.

### BACKGROUND OF THE INVENTION

Television advertising has long been a mass marketing approach. A national advertisement inserted during a program break is seen by every viewer tuned to that program, regardless of his or her location or demographic profile. Some advertising slots are left open to be filled by the local broadcast station or cable head end, which allows for geographic targeting to some extent, but not all viewers in that geographic area may be the appropriate market. This means that advertising dollars are not used to maximum efficiency; the reach is overinclusive of the desired market.

Traditional attempts to provide more targeted advertising have been limited to selecting time slots or particular programs, with the assumption that a particular type of viewer will be watching at that time or be attracted to that program. For example, baby products are traditionally advertised during daytime programming to hopefully appeal to the parent staying at home with a young child. However, the stay-at-home parent is only a small portion of the daytime viewing market. Retirees likely compose a large portion of the daytime television audience, as do children and teenagers in the summer months, none of whom are likely to be interested in diapers and baby food. Further, in many families both parents work during the day; as such, these daytime advertisements will never reach them. Television advertising is too expensive to use such rudimentary targeting techniques that provide a limited return.

The bandwidth limitations of television transmission technology have been a large impediment to increased targetability of advertising. However, with the advent of digital compression and transmission technologies for full-motion video with accompanying audio, such as Motion Pictures Experts Group (“MPEG”) standards and Internet streaming of audio and video, an ever-increasing number of programming signals can be simultaneously transmitted to a viewer's television or other reception/presentation device. These advances have provided advertisers with more programming and transmission options from which to choose when deciding where to place their advertisements. For example, MPEG compression standards have resulted in an explosion of available “channels” available within the same bandwidth over cable and direct broadcast satellite (DBS) systems, which allows advertisers to target viewers of special interest programming on particular channels who might be most receptive to the product or service advertised.

The first MPEG standard, labeled MPEG-1, is intended primarily for the encoding of video for storage on digital media such as a CD-ROM. It provides for video processing at a resolution of 352×240 pixels which is known as Source Input Format (SIF). The SIF resolution is only about one quarter of the resolution of the broadcast television standard (CCIR 601) which calls for 720×480 pixels. The MPEG-1 standard provides for bit rates for encoding and decoding full-motion video data of about 1.5 mega-bits-per-second (“Mbps”).

This resolution and bit rate was inadequate for high quality presentation of full-motion video by the broadcast and subscription television industries, so a second standard, MPEG-2, was developed. MPEG-2 provides an enhanced compression scheme to allow transmission of full-motion video at broadcast studio quality, 720×480 pixel resolution. A much higher data encode and decode rate of 6 Mbps is required by the MPEG-2 standard. Many Multi System Operators (“MSOs”) compress video at higher than 6 Mbps. For example, the AT&T® HITS system, which uses variable bit rate encoding and statistical multiplexing produces twelve channels of video with an average bit rate of approximately 1.7 Mbps. MPEG-2 is commonly used by the cable television and direct broadcast satellite industries because it provides increased image quality, support of interlaced video formats, and scalability between multiple resolutions.

A standard MPEG video stream contains different types of encoded frames comprising the full-motion video. There are I-frames (intra-coded), P-frames (predicated), and B-frames (bi-directionally predicated). A standard MPEG structure is known as a “group of pictures” (“GOP”). GOPs usually start with an I-frame and can end with either P- or B-frames. An I-frame consists of the initial, detailed picture information to recreate a video frame. The P- and B-frames consist of instructions for changes to the picture constructed from the I-frame. P-frames may include vectors which point to the I-frame, other P- or B-frames within the GOP, or a combination, to indicate changes to the picture for that frame. B-frames may similarly point to the I-frame, other P- or B-frames within the same GOP, frames from other GOPs, or a combination. The vector pointers are part of the MPEG scheme used to reduce duplication in the transmitted data, thereby resulting in the compression effects. MPEG is a packet-based scheme, so each GOP is further broken up into uniformly sized data packets for transmission in the transport stream. For additional information, the MPEG coding standard can be found in the following documents: ITU-TRec: H.222.0/ISO/IEC 13818-1 (1996-04), Information Technology—Generic Coding of Moving Pictures and Associated Audio Information: Systems; and ITU-T Rec: H.222.0/ISO/IEC 13818-1 (1996-04), Information Technology-Generic Coding of Moving Pictures and Associated Audio Information: Video.

The two major requirements of MPEG compression are 1) that the frame rate for a full-motion video presentation be 30 frames-per-second, and 2) that any accompanying audio be reconstructed in true CD-quality sound. At the MPEG-2 main level, main profile (MLMP) picture resolution of 704×480 pixels the size of a typical I-frame is about 256 Kb. Related B-frames and P-frames are substantially smaller in size as they merely contain changes from the related I-frame and/or each other. On average, one second of broadcast resolution video (i.e., 30 frames-per-second), compressed according to MPEG-2 standards, is about 2 Mb. In comparison, an I-frame in SIF resolution is approximately one quarter the size of a comparable MLMP I-frame, or about 64 Kb. CD-quality audio is defined as a 16 bit stereo sound sampled at a rate of 44.1 KHz. Before compression, this translates to a data rate of 1.411 Mbps. MPEG-2 compression provides for an audio data rate of up to about 256 Kbps. Other audio standards may be substituted for MPEG-2. For example, in the United States (“U.S.”), the Advanced Television System Committee of America's (“ATSC”) chosen audio standard is Dolby® Digital. Most cable broadcasters in the U.S. use Dolby® Digital, not MPEG audio. Over the next several years as digital television terrestrial broadcasting begins, Dolby® Digital will likewise be used in those broadcasts.

Beyond the expanded programming now available, the additional bandwidth created through digital compression and transmission technologies has provided the opportunity to transmit multiple, synchronized program streams within the bandwidth of a single 6 MHz National Television Standards Committee (NTSC) channel. U.S. Pat. Nos. 5,155,591 and 5,231,494 discuss in detail the provision of targeted advertising by either switching between separate commercials, or between related, interchangeable advertising segments, transmitted over multiple programming streams multiplexed within the same channel bandwidth.

When switching between NTSC channels to provide more advertising alternatives, the time lag required for a tuner and demodulator in a user's receiver to lock onto a new NTSC band creates significant and noticeable gaps between programming segments, as when changing a channel. This can be overcome by providing dual tuners in the receiver. However, this solution comes at an added cost for receiver components. And even then, it can still be difficult to ensure time synchronization between various transport streams across multiple NTSC bands to provide simultaneous advertising breaks in the programming.

In practice then, even with the gains made through compression technology, the number of commercials that can be simultaneously transmitted to users is still limited compared to the number of possible audience profiles an advertiser might like to target with tailored commercials. Something else is needed, therefore, to fulfill this need for greater programming customization, and for an increased ability to target advertising in particular, thereby providing advertisers increased value for their advertising dollar.

### SUMMARY OF THE INVENTION

A significantly enhanced ability to target customized advertising can be achieved by the inventive technique disclosed. Rather than continuing within the present paradigm for advertising or other programming creation, i.e. full-motion, 30 frame-per-second video with accompanying high quality audio, the methodology of the present invention is to trade off full-motion video for other forms of high quality still images, text, graphics, animation, media objects, and audio. Other content tradeoffs can include: lower resolution video (e.g., 30 frames-per-second at one-quarter resolution (352×240 pixels)); lower frame rate video (e.g., 15 frames-per-second producing “music video” effects); lower quality audio (i.e., anything between telephone and CD quality audio); and new compression techniques.

New generation set-top boxes contain very powerful processors capable of decoding and displaying different types of compressed programming content (e.g., Sony® is developing a set-top box with Play Station® capabilities). These new set-top boxes can support a variety of animation, graphics (e.g., JPEG and GIF), and audio formats. These more powerful set top boxes will enable greater efficiency in bandwidth utilization by also supporting the use of media objects that can be compressed more efficiently than full-motion video. By creating a group of synchronized digital programming components (e.g., still-frame video, audio, graphics, text, animation, and media objects), which combined utilize bandwidth less than or equivalent to a standard digital programming segment of full-motion video with CD quality sound, a greater number of differentiable programming content options can be made available in the digital transmission stream.

By “differentiable programming content,” it is meant that by selecting and combining various subsets of programming components out of a group of programming components to form programming segments, a multiplicity of programming segments, each different in content from other segments, is created. A “unit” of differentiable programming content, as used herein, can be a standard programming segment (e.g., full-motion video with audio) or a programming segment composed of a subset of programming components, regardless of the bandwidth used by the standard programming segment or the subset of components comprising the component programming segment. It should also be clear that subsets of a group of programming components can be nonexclusive, resulting in a maximum number of subsets, and thereby units of differentiable programming content, equaling the sum of all possible combinations of components. In a practical sense, this may mean that a single audio component could be combined with a multiplicity of graphic components, individually or severally, to create multiple programming segments; or each of a multiple of still video image components could be paired with each of a multiple of graphic components, creating even more programming segments (for example, four still video image components in nonexclusive combination with four graphic components could render up to 15 different subsets of programming segments).

In an audio only environment, the tradeoff can be the substitution of multiple, distinct audio tracks for a single CD quality audio signal. The invention also contemplates the system requirements, both hardware and software, for a digital programming transmission center, cable headend, satellite broadcast center, Internet hosting site, or other programming transmission source, and for a user's receiver, necessary to implement the bandwidth tradeoff methodology.

The digital programming components are preferably allocated in subsets to create greater numbers of programming segments comprised of the various programming components. For example, multiple graphics components with respective multiple audio tracks could be combined with a single still-frame video image to create a plurality of differentiable advertisements. Each of these advertisements preferably utilizes less bandwidth of the transmission stream than the bandwidth allocated to a given segment of a standard digital full motion video-audio signal. If it is desirable to provide even more advertisements in a given bandwidth, and the quality of the final picture resolution is not paramount, the still-frame video components can comprise lower resolution, scalable video frames of a much smaller data size. Audio tradeoffs for less than CD quality audio can likewise be made to increase the number of programming segment options provided within the data stream.

The present invention is also able to take advantage of elements of digital interactive programming technology. Because of the greatly expanded number of differentiable advertisements or other programming segments that can be created using the bandwidth tradeoff techniques of the present invention, greater explicitness in targeting particular content to particular users is possible. By consulting user profile information stored in an interactive programming system, particular advertisements or other programming segments, or particular variations of a central advertisement or other programming segment, can be chosen for presentation to, or provided for selection by, a particular user, or users, whose profile closely matches the audience profile targeted by the advertisement or programming content. The tradeoff techniques need not be limited to advertising purposes, however. These techniques can easily be used within the context of providing news, sports, entertainment, situation comedy, music video, game show, movie, drama, educational programming, interactive video gaming, and even live programming. They may also be used in the context of providing individualized information services such as weather reports and stock market updates.

### BRIEF DESCRIPTION OF THE DRAWINGS

FIG. 1 is a diagram depicting a preferred configuration of a MPEG data transport stream.

FIG. 2a is a diagram depicting multiple possible MPEG data transport stream scenarios for providing increased programming signals within a set bandwidth as contemplated by the present invention.

FIG. 2b is a representation of bandwidth usage of data in an MPEG data transport stream providing increased programming signals within a set bandwidth as contemplated by the present invention.

FIG. 3 is a block diagram of a preferred embodiment of a digital interactive programming system used to achieve the benefits of the present invention.

FIG. 4a is a flow diagram outlining the steps for creating targeted advertising and other programming segments for transmission according to the techniques of a preferred embodiment of the present invention.

FIG. 4b is a flow diagram outlining the steps for receiving targeted programming according to the techniques of a preferred embodiment of the present invention.

FIG. 5 is a block diagram of an interactive programming transmission center used to transmit targeted programming according to the techniques of a preferred embodiment of the present invention.

FIG. 6 is a block diagram of the components of a digital interactive programming receiver used to receive targeted programming according to the techniques of a preferred embodiment of the present invention.

### DETAILED DESCRIPTION OF THE INVENTION

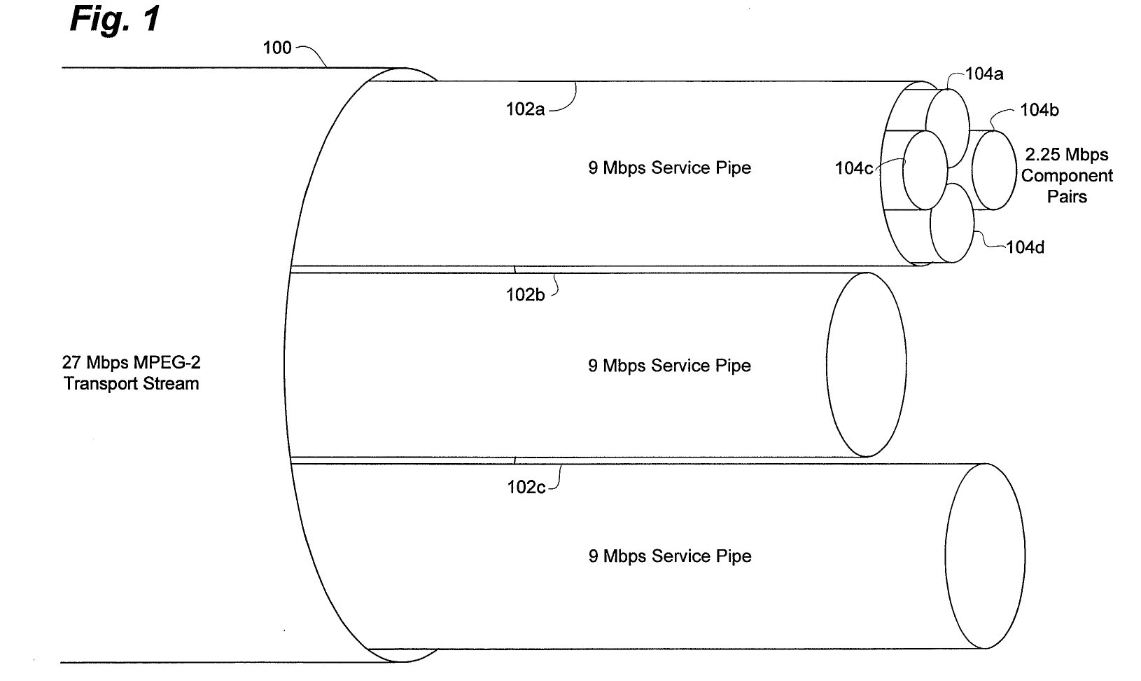

The present invention offers greater flexibility to advertisers and broadcasters for targeting a substantially increased number of user profiles with directed advertising or other programming in a standard MPEG transport stream 100, as shown in FIG. 1. The capacity of a typical MPEG-2 transport stream in a single 6 MHz NTSC channel, or “pipe” 100, utilizing 64 QAM (quadrature amplitude modulation) is about 27 Mbps. A preferred practice for a digital cable television transmission system is to subdivide the channel pipe 100 into three (3) smaller service pipes 102a, 102b, and 102c of about 9 Mbps each to provide groupings of alternate, possibly related, programming options (e.g., alternate advertisements). These programming options can be virtual “channels” available for selection by viewers, or alternate embodiments of a particular programming, or even disparate programming segments, chosen by the programming system for presentation viewers based upon demographic or other classification information. At about 2.25 Mbps each, four component pairs 104a-d of relatively high quality 30 frame-per-second video and CD quality audio can be provided per 9 Mbps service pipe 102a, b, or c (see Table 1).

TABLE 1
Standard Service Pipe (4 Component Pairs)

| Component Pair | Bit Rate |
|---|---|
| Audio/Video 1 | 2.25 Mbps |
| Audio/Video 2 | 2.25 Mbps |
| Audio/Video 3 | 2.25 Mbps |
| Audio/Video 4 | 2.25 Mbps |
| Total | 9 Mbps |

A service pipe 102a, b, or c may typically carry a single network (e.g., ESPN, WTBS, or Discovery). Four component pairs 104a-d are then able to support each network with the ability to present up to four different advertisements simultaneously.

If the same configuration is provided for each of the three service pipes 102a, b, or c, advertisers are still limited to twelve ads-up to twelve full-motion video with compact disk (“CD”) quality audio program signals per NTSC channel-to serve a user audience with potentially thousands of profiles. This twelve channel limit is exemplary of today's compression and transmission standards. New transmission standards (e.g., 256 QAM) and future compression standards may increase the number of virtual channels available in an NTSC channel bandwidth.

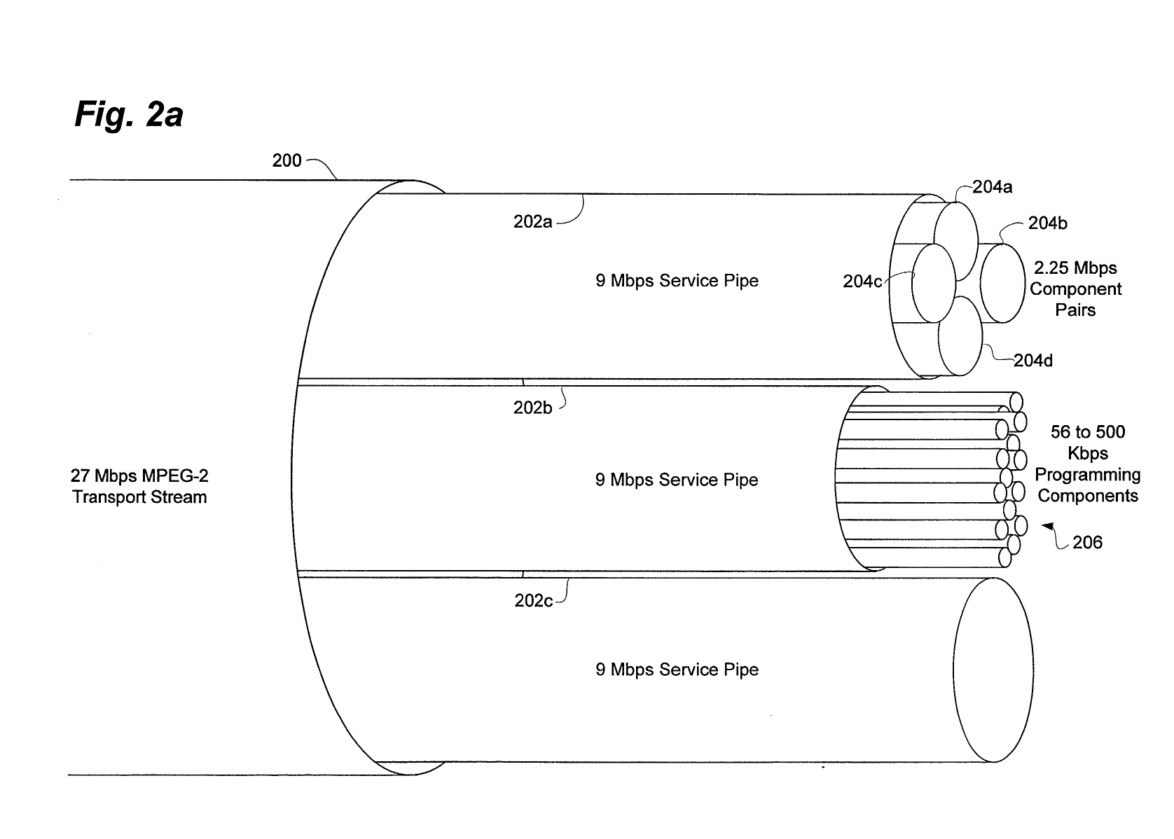

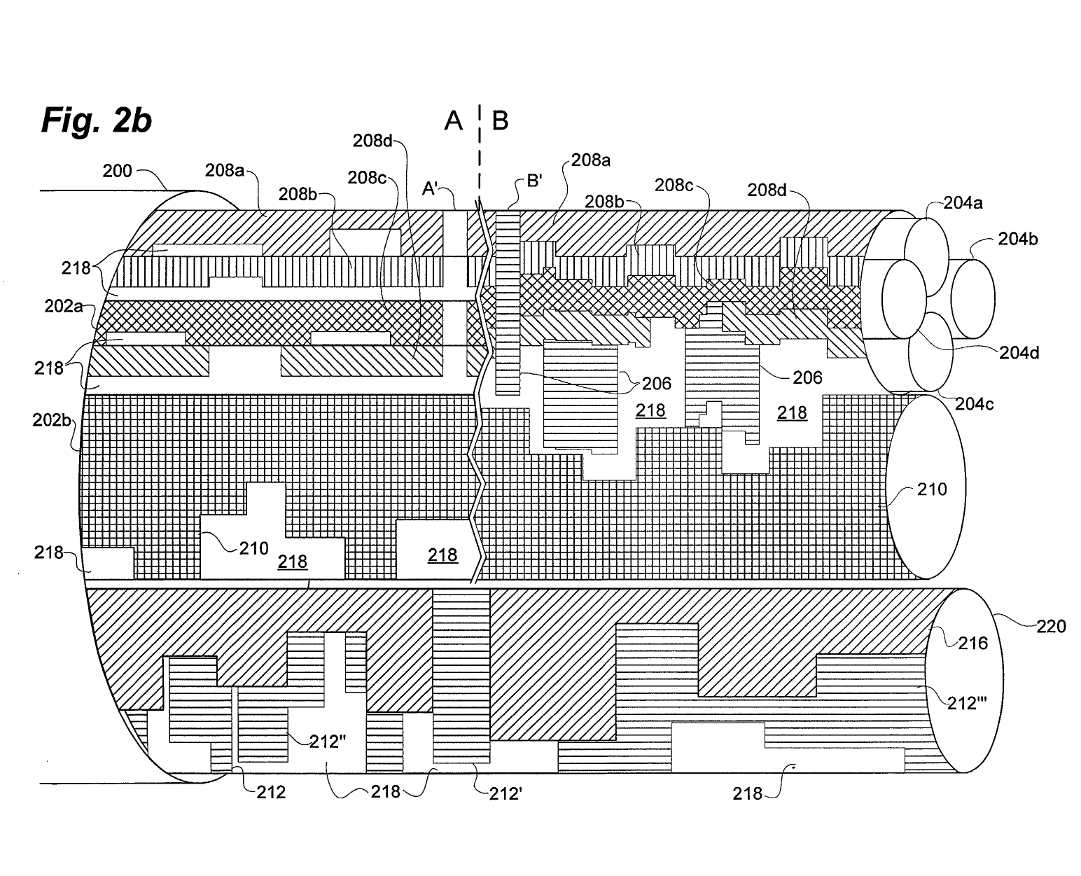

The present invention provides a methodology for surmounting this channel limit for alternate programming options. As represented in FIG. 2, by trading-off full-motion video and high quality audio component pairs 204a-d for other forms of high quality, still-frame images (e.g., I-frames), text, graphics, animation, and audio tracks, multiple versions of a common advertisement or other programming can be created and transmitted simultaneously to target more narrowly defined user profiles. Such tradeoffs are represented by the multiplicity of programming components 206 shown in service pipe 202b of FIG. 2a. Each programming component is preferably between 56 Kbps (e.g., a common sized graphic image) and 500 Kbps (e.g., an individual I-frame paired with CD quality audio), but may be greater or lesser in size depending upon the desired quality of the component.

In the alternative, or in addition, diverse messages from multiple advertisers can be offered simultaneously and targeted to appropriate audiences. Also, by placing the tradeoff components in the same service pipe 202b, or within the several service pipes 202a-c in the same transport stream 200, switches between various advertisements and programming may be made because all of the data for the programming components is in the same tuned NTSC channel bandwidth. In this way the possibilities for and availability of alternate content are maximized in the limited bandwidth of the transport stream 200.

The pipe imagery in FIG. 2a is an oversimplification of the actual transport stream, based on a commonly utilized division of the transport stream 200, in order to take advantage of the bandwidth of a 6 MHz NTSC channel and separate multiple channels transmitted thereon. FIG. 2a also does not account for the distribution of data and use of bandwidth over time. FIG. 2b is a representation of a more realistic distribution of data in a transport stream 200 overlayed over the pipe imagery of FIG. 2a. FIG. 2b also represents the temporal changes in the bandwidth utilized by data in the transport stream 200. The data distributions represented in service pipes 202a and 202b will be the focus of the following discussion.

The representation of service pipes 202a and 202b is divided into two parts, A and B. Part A is a representation of the data in the service pipes 202a and 202b before the insertion of programming components utilizing the tradeoff techniques disclosed herein. Part B is a representation of the data in the service pipes 202a and 202b after the insertion of programming components according to the present invention. Service pipe 202a is shown to contain four component pairs 204a-d, representing four full-motion video/audio streams. The actual data comprising each component pair is shown by data streams 208a-d. As seen in FIG. 2b, data streams 208a-d do not always use the entire bandwidth of service pipe 202a allocated to them. This may occur, for instance, when the video image transmitted is relatively static. Therefore, only smaller data size P- and B-frames are being transmitted. The times at which the various data streams 208a-d use less than the allocated bandwidth are indicated by the empty areas of available bandwidth 218 in the service pipe 202a, showing the decrease in bandwidth usage by the data streams 208a-d. On occasion, decreases in bandwidth among the data streams 208a-d may occur contemporaneously, as shown by the coincidence of areas of available bandwidth 218 temporally.

Service pipe 202b is depicted adjacent to service pipe 202a. The data stream 210 in service pipe 202b is depicted as of singular, homogenous content for the sake of simplicity only. Although the data stream 210 may be such a homogenous stream, it may also consist of multiple, differentiable data streams such as the audio video component pair data streams 208a-d in service pipe 202a. In part A of service pipe 202b in FIG. 2, the data stream 210 similarly does not use the entire bandwidth allocated to the service pipe 202b over time. The periods in which less than the full bandwidth is used are similarly indicated by the empty areas of available bandwidth 218. For a certain period, indicated by A′, each of the data streams 208a-d may be absent of programming data in deference to common programming content to be presented on each of the related channels at the same time, for example, selected from the data in the data stream 210 of service pipe 202b.

In part B of FIG. 2b, the application of the techniques of the present invention are indicated. In part B data streams 208a-d are represented as conglomerated, similar to data stream 210, to depict the combined available bandwidth 218 throughout service pipes 202a and 202b. This available bandwidth 218 may be exploited by inserting a multiplicity of programming components 206 or other data into the available bandwidth 218 for transmission. As one example of the use of available bandwidth, a straight tradeoff is made for the data streams 208a-d containing the four video/audio component pairs 204a-d during a period indicated by B′. In this instance, during the period B′, the regular programming is substituted, or traded off, for a multiplicity of lesser bandwidth programming components 206. In other instances, available bandwidth 218 resulting from periods of less than full bandwidth usage by the data streams 208a-d, may be utilized to transmit a multiplicity of programming components 206. Bandwidth for even more programming components 206 may be provided by using available bandwidth in the adjacent service pipe 210. This is possible because the demarcation between service pipes 202a and 202b is an artificial transmission and processing construct.

The available bandwidth 218 available for insertion of a multiplicity of programming components 206 or other data is variable over time and depends upon the bandwidth used by the program streams 208a-d and 210. Other data may include opportunistic data inserted or received by the transmission system, for example, Advanced Television Enhancement Forum (ATVEF) triggers or cable modem data. Transport pipe 220 of FIG. 2b is a representative example of the use of bandwidth tradeoffs according to the present invention taking place in a data stream, whether the data stream is a channel allocation such as data streams 208a, b, c, or d; a service pipe 202a, b, or c; multiple service pipes, e.g., service pipes 202a and 202b of FIG. 2b; or an entire transport stream 200. Transport pipe 220 should therefore not be viewed as only service pipe 202c as depicted in FIG. 2a.

In transport pipe 220 the variances in the bandwidth used by the data stream 216 depend upon both the bandwidth required to transmit the programming and any tradeoff decisions made by the content providers. Programming components 212 transmitted as tradeoffs to the data stream 216 data are also depicted in transport pipe 220. Tradeoffs within the data stream 216 for a multiplicity of programming components 212 may take several different forms. The period of time indicated by programming components 212′ shows an instance of a straight tradeoff of the data stream 216 for the multiplicity of programming components 212′. In some instances, the multiplicity of programming components 212″ may use a constant amount of bandwidth over the period in which it is transmitted. However, this need not be the case. In the alternative, the bandwidth usage of the multiplicity of programming components 212′″ may fluctuate over time depending upon the bandwidth available or necessary to provide the tradeoff programming for the presentation results desired.

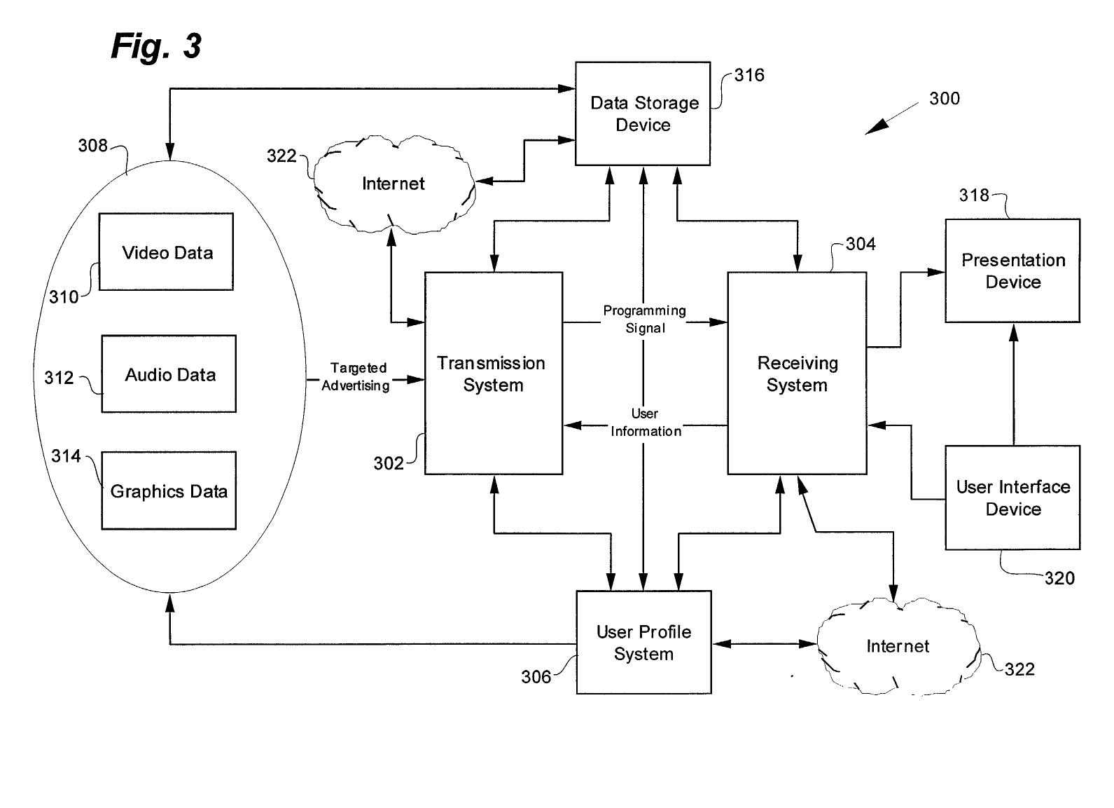

The bandwidth tradeoff techniques, described generally above and in more detail herein, are preferably implemented via a digital programming system 300 as shown in FIG. 3. Such a programming system generally consists of a transmission system 302 that transmits programming and advertising content to one or more user receiving systems 304. The transmission is preferably via a digital transport stream 200 as shown in FIG. 2. The digital transport stream may be transmitted over cable, direct broadcast satellite, microwave, telephony, wireless telephony, or any other communication network or link, public or private, such as the Internet (e.g., streaming media), a local area network, a wide area network, or an online information provider. The transmission system 302 accesses the programming components, such as video data 310, audio data 312, and graphics data 314, and transmits the programming components to receiving systems 304 utilizing the novel bandwidth tradeoff techniques. The programming components may also consist of media objects, as defined under the MPEG-4 standard, that are created, for example, from the video data 310, audio data 312, and graphics/textual data 314, by a media object creator 308.

The receiving system 304 is preferably any device capable of decoding and outputting digital audio/video signals for presentation to a user. The receiving system 304 is preferably connected to a presentation device 318 to present output programming and advertising content to the user. Any devices capable of presenting programming and advertising content to users may be utilized as the presentation device 318. Such devices include, but are not limited to, television receivers, home theater systems, audio systems, video monitors, computer workstations, laptop computers, personal data assistants, set top boxes, telephones and telephony devices for the deaf, wireless communication systems (for example, pagers and wireless telephones), video game consoles, virtual reality systems, printers, heads-up displays, tactile or sensory perceptible signal generators (for example, a vibration or motion), and various other devices or combinations of devices. In some embodiments, the receiving system 504 and the presentation device 512 may be incorporated into the same device. In short, the presentation device 318 should not be construed as being limited to any specific systems, devices, components or combinations thereof.

A user interface device 320 preferably interfaces with the receiving system 304 allowing the user to control or interact with the presentation device 318. Numerous interface devices 320 may be utilized by a user to identify oneself, select programming signals, input information, and respond to interactive queries. Such interface devices 320 include radio frequency or infrared remote controls, keyboards, scanners (for example, retinal and fingerprint), mice, trackballs, virtual reality sensors, voice recognition systems, voice verification systems, push buttons, touch screens, joy sticks, and other such devices, all of which are commonly known in the art.

The programming system 300 also preferably incorporates a user profile system 306. The user profile system 306 collects information about each of the users or groups of users receiving programming from the transmission system 302. Information in the user profile system 306 can be collected directly from a user's receiving system 304, or indirectly through the transmission system 302 if the information is routed there from the receiving system 304. Information collected by the user profile system 306 can include demographic information, geographic information, viewing habits, user interface selections or habits (for example, by tracking selections between advertising options by the user via the interface device 320 (user clicks)), and specific user preferences based, for example, upon user selection and responses to interrogatories provided via interactive programming signals. The user profile system 306 can be integrated as part of the receiving system 304 or the transmission system 302, it can be a stand-alone system that interfaces with the rest of the programming system 300, or it can be a distributed system residing across the various subsystems of the programming system 300. Further, the user profile system can contain algorithms as known in the art for selecting, aggregating, filtering, messaging, correlating, and reporting statistics on groups of users.

Additionally, a data storage device 316 is preferably utilized in the programming system 300 for the temporary or permanent storage of video component data 310, audio component data 312, graphics component data 514, media objects, the content provided in the media objects, transmission signals (for example, in decompressed and/or demultiplexed formats), user profile information, operating routines, and/or any other information utilized by the programming system 300. The data storage device 316 may be provided in conjunction with the receiving system 304, may be a stand-alone device co-located with the receiving system 304, may be remotely accessed (for example, via an Internet connection), may be provided with the transmission system 302, with the user profile system 306, with the media object creators 308, or at any other location in the programming system 300. The data storage device 316 may also utilize a combination of local and remote storage devices in order to provide the desired features and functions of the interactive programming system 300. Various data storage devices 316, algorithms, programs, and systems may be utilized in conjunction with the interactive programming system 300. Examples of such data storage devices 316 include, but are not limited to, hard drives, floppy disks, tape drives, and other magnetic storage media, CD ROMS, digital video disks and other optical storage media, memory sticks, file servers and other digital storage media, and including remote databases and local databases.

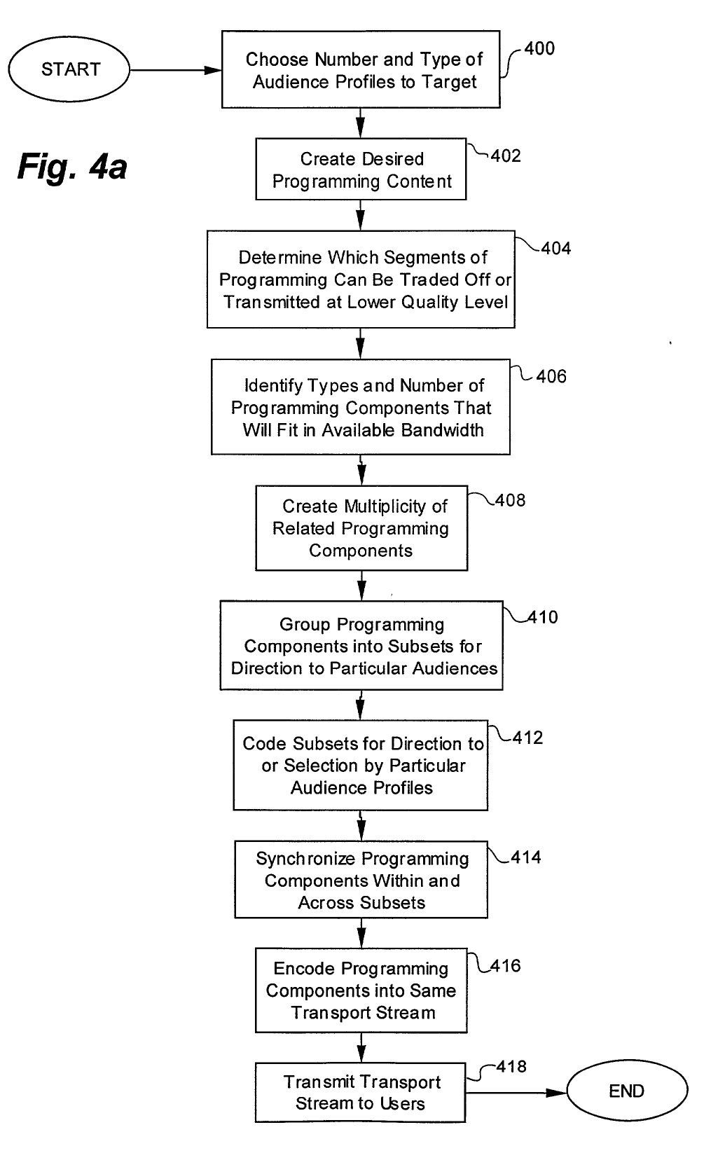

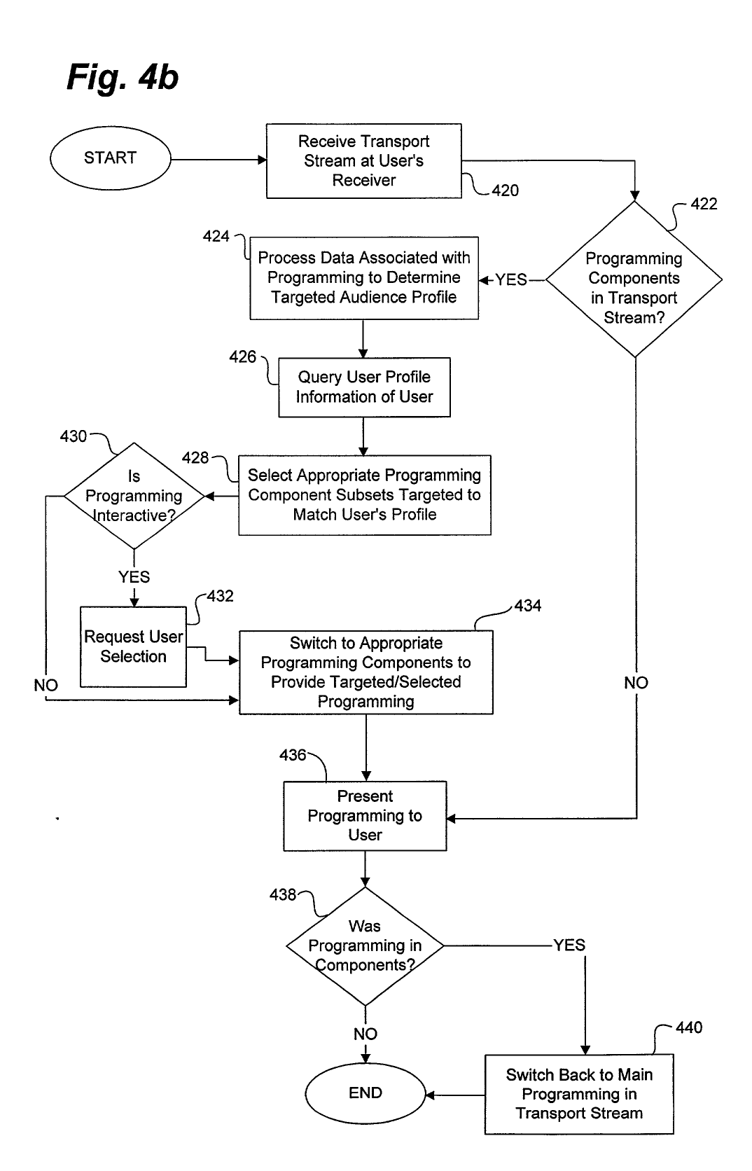

A preferred method of implementing the bandwidth tradeoff techniques discussed herein is represented by the flow charts in FIGS. 4a and 4b. FIG. 4a outlines the procedures for creating and transmitting programming from a transmission center 302. Initially, a creator of programming content determines the types of audience profiles that the creator desires the programming to reach, step 400. The creator next develops a comprehensive programming concept designed to provide content targeted to each audience profile, step 402. Development of such a concept can translate into optional content segments specifically designed to appeal to a particular audience. For example, an advertisement for a car could couple a single video segment of the car with multiple audio tracks designed to appeal to different audiences. For targeting a profile of a family with small children, the audio voice-over could tout the safety features of the vehicle. In an alternative segment, the voice-over track could highlight the engine horsepower to appeal to a younger, male profile.

Once the concept has been planned to appeal to the desired types and numbers of audiences, the content creator must determine which segments of optional programming content can be traded off for alternative forms of content and which segments can be transmitted at a lower quality level, step 404. For example, a still-frame video image could be substituted for full-motion video of the car provided in the example above. In an alternative arrangement, multiple still-frame video images of multiple car models could instead be provided. The determination of appropriate tradeoffs must be done in conjunction with an appraisal of the available bandwidth and a calculation of the types and numbers of alternative programming content that can fit in the available bandwidth, step 406. Once this calculation is completed, the programming creator can then actually create the desired multiplicity of programming components that will provide programming targeted to the various desired audiences without exceeding the known bandwidth limitations, step 408. Such programming components can include any of the variety of combinations of audio, video, graphic, animated, textual, and media object components previously indicated and discussed in exemplary fashion below.

Once the programming components are created, they must be assembled for transmission to users. This assembly initially involves grouping the programming components into subsets, each subset consisting of a complete program segment, step 410. These program segments may be directed to a particular audience profile for automatic selection by the receiving system 304, or any or all of the program segments may be offered for selection by individual users via the user interface device 320. Again referring to the car advertisement example, this could mean pairing full-motion video of the car multiple times with the different audio tracks; or it could mean various pairings of multiple still-frame video images of cars with the related audio tracks. This does not mean that multiple copies of any one component, e.g., the full-motion car video, are made or eventually transmitted. Identification tags are assigned to each programming component for encoding the subsets, step 412. A data table of the identification tags is then constructed to indicate the program components as grouped into the subsets. The data table is transmitted with the programming components for later use in selection of targeted components by a user's receiving system. The programming components are preferably created to include and to be transmitted with data commands for determining the appropriate selection of component subsets for presentation to each particular user.

Once the programming component subsets are created and encoded, they must further be synchronized with each other and across the subsets, step 414. Synchronization ensures that the presentation of the multiple, targeted programming segments to various users will begin and end at the same time. For example, television advertisements are allotted very discrete periods of time in which to appear, e.g., 30 seconds, before presentation of the next advertisement or return to the primary programming. The targeted programming segments must each begin and end within the set time period in order to maintain the rigors of the transmission schedule.

After synchronization, the programming components are preferably encoded into the same transport stream, step 416. By encoding the programming components into the same transport stream, selection of and switches between the various components for presentation by a receiving system is facilitated. MPEG-2 encoding is preferred, but any form of digital encoding for creating a compressed transport stream is contemplated within the scope of this invention. The final step in the creation and transmission process is actually transmitting the transport stream with the programming components to one or more users, step 418. Such a transmission may be made by sending the digital data over an analog carrier signal (e.g., cable and DBS television systems) or it may be wholly digital (e.g., streaming media over the Internet on a digital subscriber line). The transmission system 302 can also transmit more than one set of programming content (e.g., separate advertisements from separate advertisers) in the same transport stream, each potentially with multiple programming components, if there is available bandwidth not used by one set of programming content alone.

FIG. 4b details the process undertaken at a user's receiving system 304 when programming content with multiple components is received in a transmission. When the transport stream 200 arrives at a user reception system 304, step 420, the reception system 304 first makes a determination of whether or not the transport stream 200 is encoded to indicate the presence of a component grouping transmitted utilizing the bandwidth tradeoff techniques, step 422. If the programming is not composed of components, the receiving system 304 immediately processes the programming according to normal protocols for presentation to the user, step 436. If the transport stream 200 contains targeted component groups, the receiving system 304 processes the data commands to determine appropriate audience profiles targeted by the programming, step 424. The receiving system 304 next queries the user profile system 306 for information about the user stored within the interactive programming system 300, step 426, and attempts to match a component combination to extract a targeted programming segment from the transport stream 200 fitting the user's profile, step 428.

In addition to selecting programming segments by matching a user profile, the process in the receiving system 304 may also provide for presenting interactive programming components. The process therefore determines whether the component combination is interactive (i.e., requires a user response), step 430, and thus needs to solicit and capture a user response. If the programming is not interactive, the process continues to step 434 where the receiving system 304 switches from the main programming content in the transport stream 200 to one or more appropriately targeted programming components selected from the programming component set in step 428. The targeted programming is then presented to the user on the presentation device 318, step 436.

If the programming is interactive, the process solicits a selection response from the user, step 432. This request for response may be in the form of a prior programming segment providing an indication of choices to the user for selection, for example via the user interface 320. Once the user selection is made, the process continues to step 434 where the receiving system 304 switches from the main programming content in the transport stream 200 to user selected programming segment made up of appropriate components. The selected programming is then presented to the user on the presentation device 318, step 436. For example, if an advertisement containing an I-frame image of a minivan is presented, the user can make program segment selections that are more personally relevant. A safety concerned user may choose to see safety features of the minivan. In this instance, the program components used to create a segment corresponding to the user selection may be a graphics overlay and audio track illustrating the airbag system in the vehicle. In an alternative, a reliability focused user may wish to see the reliability ratings of the vehicle. The components comprising the program segment in this scenario may include a graphics overlay, perhaps in a bar chart format, and an audio track illustrating the reliability of the minivan.

After the programming is presented, the receiving system 304 performs a check to recall whether the selected programming was a targeted or selected component set, step 434. If so, the receiving system 304 recognizes that it must switch back to the data stream containing the main programming content, step 436, and then the process ends. If the programming was not composed of a group of component segments for targeting, there is no need for the receiving system 304 to make any data stream switch and the process ends without any further switching in the transport stream 200.

Several examples of programming component configurations that could be created for transmission and reception in the steps of FIGS. 4a and 4b follow. These examples consist of audio, video, and graphical programming components; however, other components such as text, animation, and media objects could also be used. These configurations are merely examples and should not be construed as limiting the number and type of possible component configurations. Such configurations are represented in FIG. 2 by the multiplicity of component pairs 206 in a 9 Mbps service pipe 202. An average graphic file size of about 56 Kb is used in these examples.

In Table 2 a configuration of exclusive pairings of multiple still-frame video (e.g., 256 Kb I-frames at 1 frame-per-second) streams and multiple audio tracks is shown. At a combined bit rate of only about 500 Kbps per exclusive audio/visual paring, up to 18 different commercials could be transmitted within the same service pipe 102, or 54 within an entire transport stream 100. If the content of the audio/video components was developed such that nonexclusive subset pairings were sensible, up to 289,275 possible combinations of components equating to separate units of differentiable programming content are mathematically possible.

TABLE 2
1 I-frame/second + Audio
(18 exclusive component pairs; 289,275 potential combinations)

| Component Pair | Bit Rate |
|---|---|
| Audio 1 + I-frame 1 | 512 Kbps |
| Audio 2 + I-frame 2 | 512 Kbps |
| Audio 3 + I-frame 3 | 512 Kbps |
| . . . | . . . |
| Audio 18 + I-frame 18 | 512 Kbps |
| Total | 9.216 Mbps |

If instead an SIF I-frame was used and less than CD quality audio was acceptable, for example 64 Kb audio, up to 70 different advertisements could be offered in the same service pipe 102, or 210 advertisements in the transport stream 100.

In another example, Table 3, multiple still-frame video components are combined with related graphics in pairs. At a total bit rate of 290 Kbps per component pair, up to 30 different exclusively paired targeted advertisements, and potentially tens of millions of nonexclusive component subsets, could be transmitted over the same service pipe 102 to a multiplicity of user profiles.

TABLE 3
1 I-frame/second + Graphics
(30 exclusive component pairs; tens of millions of potential
combinations)

| Component Pair | Bit Rate |
|---|---|
| Graphic 1 + I-frame 1 | 312 Kbps |
| Graphic 2 + I-frame 2 | 312 Kbps |
| Graphic 3 + I-frame 3 | 312 Kbps |
| . . . | . . . |
| Graphic 30 + I-frame 30 | 312 Kbps |
| Total | 9.36 Mbps |

Table 4 depicts a third possible configuration wherein an audio signal is paired with still frame video and additional audio tracks are paired with graphic images. This configuration can similarly provide up to 30 component pairs, or up to tens of millions of nonexclusive component subsets, of programming to realize greater profile addressability in advertising. The graphics may additionally be combined with the still frame video to create multiple composite advertisements with respective particularized audio tracks.

TABLE 4
1 I-frame/second Component with Audio + Many Audio/Graphics
Component Pairs
(30 exclusive component pairs; tens of millions of potential
combinations)

| Component Pair | Bit Rate |
|---|---|
| Audio 1 + I-frame | 500 Kbps |
| Graphic 1 + Audio 2 | 290 Kbps |
| Graphic 2 + Audio 3 | 290 Kbps |
| . . . | . . . |
| Graphic 29 + Audio 30 | 290 Kbps |
| Total | 8.91 Mbps |

The exemplary components in Table 4 could also be mixed in other combinations such as 10 audio/video still pairs and 13 audio/graphic pairs, or whatever combinations do not exceed a total bit rate of about 9 Mbps per service pipe 202. The number of component mixes could also be expanded to fill the entire transport stream, 200.

In Table 5, a combination of one video still frame and 150 separate graphics are shown as transmitted simultaneously. Displaying the video still in combination with a selected graphic translates to up to 150 possible differentiations to an advertising message to target specific profiles. This further translates into 450 alternate messages if all three service pipes 102 are used to capacity. If multiple graphics were combined in additional, nonexclusive subsets beyond individual pairings with the video still frame, almost innumerable potential combinations are mathematically possible.

TABLE 5
1 I-frame/second Component + Many Graphics Components
(150 exclusive component pairs; millions upon millions of
nonexclusive component subsets)

| Components | Bit Rate |
|---|---|
| I-frame 1 | 256 Kbps |
| Graphic 1 | 56 Kbps |
| Graphic 2 | 56 Kbps |
| . . . | . . . |
| Graphic 150 | 56 Kbps |
| Total | 8.656 Mbps |

Again, Tables 2-5 are merely examples of combinations of audio, video, and graphics that can be transmitted within a service pipe 204. Any combination of audio, video, video stills, graphics, or text that does not exceed about 27 Mbps (for 64 QAM)can be used to provide targeted advertising options based upon a multiplicity of user profiles within the same MPEG-2 transport stream 200. In addition to the advertising possibilities, such component tradeoff techniques may be incorporated into any type of programming, such as news, sports, entertainment, music videos, game shows, movies, dramas, educational programming, and live programming, depending upon the needs and desires of the content creator.

If even greater programming component options are necessary or desired, other options for tradeoff are available, for example, video formats not contemplated for television quality presentation. As noted above, under the MPEG-1 SIF the picture resolution is only 352×240 pixels at 30 frames per second-less than broadcast quality. MPEG-1 is geared to present video in a small picture form for small screen display devices. If presented on a television or computer monitor, it would use only about a quarter of the screen size. The MPEG-1 SIF, however, is designed to be scalable and fill a larger screen with a consequent tradeoff in the resolution. It generally is used in this lower resolution manner for presentation of computer video games on computer monitors, where a high resolution picture is not necessary or expected by users. If the video decoder can present the SIF image without up-sampling it to cover the entire screen, the visible artifacts will be reduced. For example, a SIF image could be displayed in a quadrant of a television display. The rest of the display could be filled with graphics. In this case a lower resolution picture or an I-frame could be used as an anchor for other graphics images to enhance.

As MPEG-2 is a backward compatible standard, and MPEG-1 is a scalable standard, most MPEG-2 decoders can similarly process and scale an MPEG-1 encoded video frame by interpolating additional pixels to fully fill a display screen. (Not all set-top boxes can decode MPEG-1 video, however. For example, the Motorola® DCT2000 does not support MPEG-1 video. It does, however, support lower resolution video such as 352×480 pixels.) Recalling that an I-frame encoded in the MPEG-1 format is compressed to about 64 Kb, a quarter of the size of an MPEG-2 I-frame, for applications in which the picture resolution and detail is not critical, the capacity of advertisements per service pipe shown in Table 2 can be increased from 18 to 28. Similar significant leaps in capacity are possible with each of the examples previously discussed, as well as with any other configuration, if the tradeoff in resolution is acceptable to the particular application.

The presentation scalability in video decoders subscribing to MPEG standards is based in macro block units (16×16 pixels). Therefore, video frames and other images may be compressed from any original macro block dimension resolution (e.g., half screen at 528×360 pixels), and upon decompression for display by the user's equipment, scaled up (or down) to fit the appropriate presentation device. For example, video or other images anywhere between SIF (or lower) and full resolution MPEG-2 could be used depending upon available bandwidth, presentation resolution requirements, and video decoder capabilities. In combination with similar scaling of the audio signal, a desired balance between bandwidth optimization, image/audio quality, and advertisement customization to reach multiple user profiles can be achieved.

Although the previous examples have been directed to MPEG compression standards and television transmission systems, the techniques disclosed herein are completely standard, platform, and transmission system independent. For instance, it should be apparent that other compression formats, such as wavelets and fractals, could also be utilized for compression. The inventive techniques are applicable for use with any device capable of decoding and presenting digital video or audio. For example, although the transmission streams of DBS signals to users do not fall into the NTSC bandwidths, satellite transmissions do separate the programming onto individual transport stream pipes that are similarly of limited bandwidth. The processes described herein can similarly provide a substantially greater number of targeted segments composed of programming components within the satellite bandwidth limitations.

As another example, the Common Intermediate Format (CIF) resolution of 352×288 pixels and H.261 and H.263 transmission standards for video teleconferencing could be used to deliver programming as described herein over a telephone or other network. If even more alternative programming components were desired, Quarter CIF (QCIF) resolution video at a resolution of 144×176 pixels could be used to save bandwidth. These video programming images are similarly scalable and could be presented to a user on any suitable presentation device. Switched digital video and DSL or VDSL transmission systems can likewise be used. Although each user location might have only one “pipe” coming from a head end or central office, multiple users at the same location using different decoding devices could be presented different programming based upon individual user profiles.

As a general matter, the bandwidth tradeoff techniques are applicable to any form of digital compression methodology capable of providing compressed signals for transmission or playback. A programming component relationship scheme, such as the MPEG-4 format, can also be used in conjunction with the inventive bandwidth tradeoff techniques disclosed herein. The MPEG-4 standard was promulgated in order to standardize the creation, transmission, distribution, and reception of “media objects” based upon audio, video, and graphical components, and various other forms of data and information. As used herein, “media objects” are defined in accordance with the definitions and descriptions provided in the “Overview of the MPEG-4 Standard” provided by the International Organization for Standardization, ISO/IEC JTC 1/SC29/WG11 N3444, May/June 2000/Geneva, the contents of which are herein incorporated by reference. More specifically, media objects are commonly representations of aural, visual, or audio-visual content which may be of natural or synthetic origin (i.e., a recording or a computer generated object).

Such media objects are generally organized in a hierarchy with primitive objects (for example, still images, video objects, and audio objects) and coded representations of objects (for example, text, graphics, synthetic heads, and synthetic sounds). These various objects are utilized to describe how the object is utilized in an audio, video, or audio-visual stream of data and allow each object to be represented independently of any other object and/or in reference to other objects. For example, a television commercial for an automobile may consist of an automobile, a scene or route upon which the automobile travels, and an audio signal (for example, a voice describing the characteristics of the automobile, background sounds adding additional realism to the presentation, and background music). Each of these objects may be interchanged with another object (for example, a car for a truck, or a rock soundtrack for an easy listening soundtrack), without specifically affecting the presentation of the other objects, if so desired by the content creator. In the context of bandwidth tradeoffs, advertisements can now be created with a combination of still frame video, graphics, audio, and MPEG-4 objects to provide even more options for targeted advertising to a multiplicity of viewers. See copending U.S. application serial no. ______ filed Apr. 12, 2001 entitled System and Method for Targeting Object-Oriented Audio Video Content to Users, which is herby incorporated herein by reference, for additional explanation of the use of media objects and MPEG-4 in advertising and other programming creation.

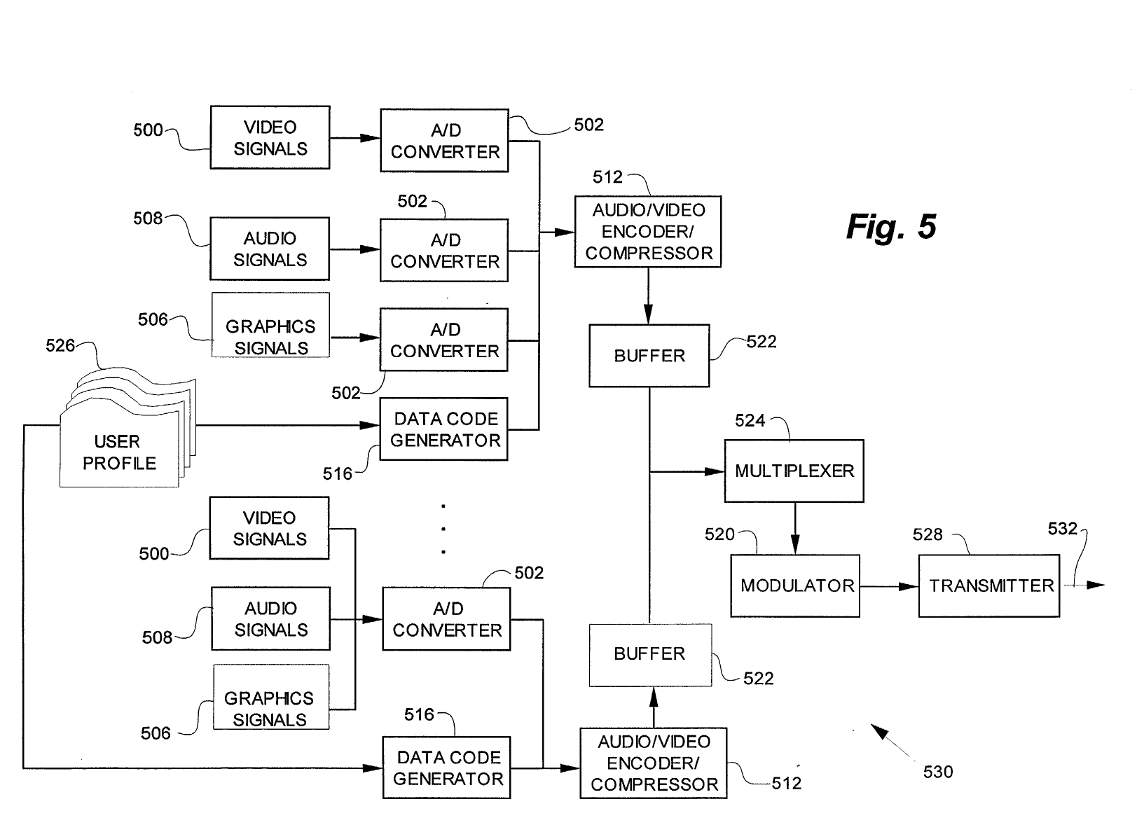

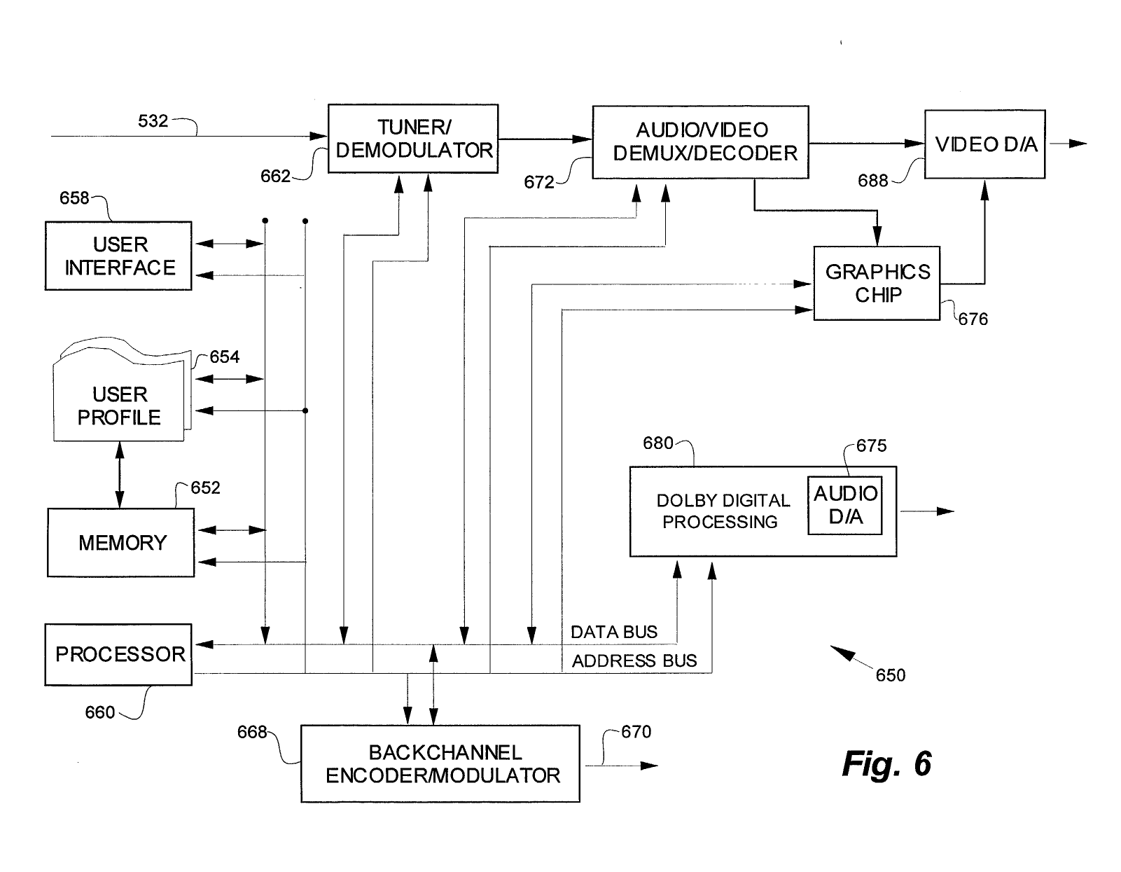

A detailed depiction of a preferred embodiment of an interactive television programming system for providing targeted programming using the bandwidth tradeoff techniques is shown in FIGS. 5 and 6. FIG. 5 details a transmission system 530, such as a cable headend or a DBS uplink center, where a plurality of video signals 500, audio signals 508, graphic signals 506, and other programming signals (not shown) such as media objects, text signals, still frame image signals, multimedia, streaming video, or executable object or application code (all collectively “programming signals”), from which the programming components are composed, is simultaneously transmitted to a plurality of users. FIG. 6 details the components of a receiver 650 in an interactive television programming system that selects the appropriate programming components for the particular user and processes them for presentation.

Targeted programming components created according to the methods detailed above are preferably provided to a cable headend, DBS uplink, or other distribution network in pre-digitized and/or precompressed format. However, this may not always be the case and a preferred transmission system 530 has the capability to perform such steps. As shown in FIG. 5, video signals 500, audio signals 508, graphic signals 506, or other programming signals, are directed to analog-to-digital (“A/D”) converters 502 at the transmission system 530. The origin of the video signals 500 can be, for example, from video servers, video tape decks, digital video disks (“DVD”), satellite feeds, and cameras for live video feeds. The video signals 500 which comprise part of the targeted advertising in the transmission may already be in digital form, such as MPEG 2 standards, high definition television (“HDTV”), and European phase alternate line (“PAL”) standards, and therefore may bypass the A/D converters 502. A plurality of audio signals 508, which may be a counterpart of the video signals 500, or which may originate from compact digital disks (“CD”), magnetic tapes, and microphones, for example, is also directed to A/D converters 502 if the audio signals 508 are not already in proper digital format. Preferably, the audio signals 508 are digitized using the Dolby® AC-3 format; however, any conventional audio A/D encoding scheme is acceptable. Similarly, any desired graphics signals 506 that may be stored on servers or generated contemporaneously via computer or other graphic production device or system are also directed, if necessary, to A/D converters 502.

As is well known in the art, the A/D converters 502 convert the various programming signals into digital format. A/D converters 502 may be of any conventional type for converting analog signals to digital format. An A/D converter 502 may not be needed for each type of programming signal, but rather fewer A/D converters 502, or even a single AID converter 502, are capable of digitizing various programming signals.

The data codes emanating from the data code generator 516 in FIG. 5 may be, for example, the commands used by the transmission system 530 and/or a receiver 650 (see FIG. 6) for controlling the processing of targeted programming components, updates of system software for the receiver 650, and direct address data for making certain programming available to the user (e.g., pay-per-view events). Preferably, the data codes originating in the data code generator 516 are part of an interactive television scripting language, such as ACTV® Coding Language, Educational Command Set, Version 1.1, and ACTV® Coding Language, Entertainment Command Extensions, Version 2.0, both of which are incorporated herein by reference. These data codes facilitate multiple programming options, including the targeted programming component tradeoffs, as well as a synchronous, seamless switch between the main programming and the desired targeted programming components arriving at the receiver 650 in the transport stream 532. The data codes in the transport stream 532 provide the information necessary to link together the different targeted programming components comprised of the associated programming signals. The data codes preferably incorporate instructions for the receiver 650 to make programming component subset selections following user profile constructs 526 based upon information in the user profile system 306 (of FIG. 3) compiled about the user of each receiver 650. The data codes may also key selection of a programming component subset on the basis of user input, feedback, or selections.

The digitized, time synchronized programming signals are then directed into the audio/video encoder/compressor (hereinafter “encoder”) 512. Compression of the various signals is normally performed to allow a plurality of signals to be transmitted over a single NTSC transmission channel. Preferably, the encoder 512 uses a standard MPEG-2 compression format. However, MPEG-1 and other compression formats, such as wavelets and fractals, could be utilized for compression. Various still image compression formats such as JPEG and GIF could be used to encode images, assuming that the receiver 650 is capable of decoding and presenting these image types. These techniques are compatible with the existing ATSC and digital video broadcasting (“DVB”) standards for digital video systems.

Because of the ability of compression technology to place more than one programming “channel” in an NTSC channel, switches between programming streams within a channel are undertaken by the receiver 650. Under normal MPEG protocol, these switches appear as noticeable gaps in the programming when presented to a user, similar to tuning delay when switching between normal NTSC channels. Certain modifications, however, may be made to the MPEG stream before transmission in order to facilitate a preferred “seamless” switch between program streams wherein there is no user perceptible delay between programming presentations. These modifications to the MPEG encoding scheme are described in detail in U.S. Pat. Nos. 5,724,091; 6,181,334; 6,204,843; 6,215,484 and U.S. patent application Ser. Nos. 09/154,069; 09/335,372; and 09/429,850 each of which is entitled “Compressed Digital Data Seamless Video Switching System” and is hereby incorporated herein by reference.

In brief, to achieve a seamless switch between video packets in separate program streams, splices between and among the main programming stream and desired targeted programming component subsets take advantage of the non-real-time nature of MPEG data during transmission of the transport stream 532. Because the audio/video demultiplexer/decoder/decompressor 672 (hereinafter “decoder 672”) at the receiver 650 can decompress and decode even the most complex video GOP before the prior GOP is presented on the presentation device 318, the GOPs can be padded with the switching packets, including time gap packets, without any visual gap between the programming and the targeted advertisements presented. In this way, separate video signals 500 are merged to create a single, syntactical MPEG data stream 532 for transmission to the user.

In addition, especially with interactive programming systems generally, and for the implementation of the bandwidth tradeoff schemes of this invention particularly, if multiple encoders 512 are used to create a multiplicity of targeted programming components, the encoders 512 are preferably synchronized to the same video clock. This synchronized start ensures that splice points placed in the MPEG data packets indicate the switch between programming components, particularly from or to video signals 500, so that it occurs at the correct video frame number. SMPTE time code or vertical time code information can be used to synchronize the encoders 512. This level of synchronization is achievable within the syntax of the MPEG-2 specifications. Such synchronization provides programming producers with the ability to plan video switch occurrences between separately encoded and targeted programming components on frame boundaries within the resolution of the GOP.

All of the digitized programming signals comprising targeted programming components are packetized and interleaved in the encoder 512, preferably according to MPEG specifications. The MPEG compression and encoding process assigns packet identification numbers (“PID”s) to each data packet created. Among other information, the PID identifies the type of programming signal in the packet (e.g., audio, video, graphic, and data) so that upon reception at a receiver 650, the packet can be directed by a demultiplexer/decoder 672 (hereinafter “demux/decoder 672”; see FIG. 6) to an appropriate digital-to-analog converter. PID numbers may be obtained from the MPEG-2 Program Specific Information (PSI). Program Association Tables (PAT) and Program Map Tables (PMT) documentation.

MPEG encoding also incorporates a segment in each data packet called the adaptation field that carries information to direct the reconstruction of the video signal 500. The program clock reference (“PCR”) is a portion of the adaptation field that stores the frame rate of an incoming video signal 500, clocked prior to compression. The PCR includes both decode time stamps an presentation time stamps. This is necessary to ensure that the demux/decoder 672 in the receiver 650 can output the decoded video signal 500 for presentation at the same rate as it was input for encoding to avoid dropping or repeating frames.

When still frame images are used according to the techniques of the present invention, the GOP may consist of I-frames only. These I-frames are rate controlled in order to maintain the proper buffer levels in the decoding device. For example, if the I-frame based programming segment presents one I-frame per second, the I-frames will be encoded at a lower than 30 frame-per-second rate in order to keep the buffer at a decoder in a reception system 304 at an appropriate level. The decode time stamps and presentation time stamps for still frame image presentation will therefore be adjusted to decode and present a one frame-per-second video stream at appropriate times. Similarly, still images based on JPEG, GIF, and other graphic file formats must be coded for presentation at appropriate rates. In order to effect the presentation rate for other images, the decoder at the reception system 304 is preferably controlled by a software script such as A CTV Coding Language, Educational Command Set, Version 1.1 and ACTV Coding Language, Entertainment Command Extensions, Version 2.0, both of which are hereby incorporated herein by reference.

Similar to the video signal 500 encoding, switching between audio signals 508 preferably occurs on frame boundaries. Audio splice points are inserted in the adaptation fields of data packets by the encoder 512 similar to the video splice points. Preferably, the encoder 512 inserts an appropriate value in a splice countdown slot in the adaptation field of the particular audio frame. When the demux/decoder 672 at the receiver 650 (see FIG. 6) detects the splice point inserted by encoder 512, it switches between audio channels supplied in the different program streams. The audio splice point is preferably designated to be a packet following the video splice point packet, but before the first packet of the next GOP of the prior program stream. When switching from one channel to another, one frame may be dropped resulting in a brief muting of the audio, and the audio resumes with the present frame of the new channel. Although the audio splice is not seamless, the switch will be nearly imperceptible to the user.

The data codes generated by the data code generator 516 are time sensitive in the digital embodiments and must be synchronized with the video GOPs, as well as audio and graphics packets, at the time of creation and encoding of the targeted programming components. Data codes are preferably formed by stringing together two six byte long control commands; however, they can consist of as few as two bytes, much less than the standard size of an MPEG data packet. MPEG protocol normally waits to accumulate enough data to fill a packet before constructing a packet and outputting it for transmission. In order to ensure timely delivery of the data codes to the receiver 650 for synchronization, the encoder 512 must output individual data code commands as whole packets, even if they are not so large in size. If a data code command only creates a partial packet, the default process of the encoder 512 is to delay output of the data code as a packet until subsequent data codes fill the remainder of the packet. One technique that can ensure timely delivery of the data codes is to cause the data code generator 516 to create placeholder bytes to pad the remaining bytes for a packet. When the encoder 512 receives this data code with enough data for a whole packet, the encoder 512 will output the packet for transmission at its earliest convenience, assuring synchronous receipt of the data codes at the receiver 650 with the corresponding targeted programming components.

After the various digitized programming signals are compressed and encoded, they are further rate controlled for transmission by the buffer 522. The buffer 522 controls the rate of transmission of the data packets to the receiver 650 so that it does not overflow or under-fill while processing. The physical size of the buffer 522 is defined by the MPEG standard. Enough time must be allowed at the onset of the transmission process to fill up the buffer 522 with the compressed data to ensure data availability for an even transmission rate.

The multiplexer 524 combines the encoded and compressed digital signals comprising the targeted programming components with other programming and data to create a transport stream 200 (FIG. 2) for transmission over NTSC channels. By multiplexing a plurality of disparate signals, the number of transport streams 200 carried by the transmission broadcast 532 is reduced. The transport stream 200 is then modulated for transmission by modulator 520. The modulator 520 may utilize one of several different possible modulation schemes. Preferably, 64-QAM or 256-QAM (quadrature amplitude modulation) is chosen as the modulation scheme; however, any other conventional modulation scheme such as QPSK (quadrature phase shift keying), n-PSK (phase shift keying), FSK (frequency shift keying), and VSB (vestigial side band), can be used. With 64-QAM, the data rate at the output of the modulator 520 is around 27 Mbps; with 256-QAM, the data rate is about 38 Mbps. In Tables 1-5 and in FIG. 2, a data rate of about 27 Mbps is chosen to provide headroom in the transport stream 200 for non-content data, e.g., the data codes. Examples of other modulation schemes that can be used with the present invention, with respective approximate data rates, include: 64-QAM-PAL (42 Mbps), 256 -QAM-PAL (56 Mbps), and 8-VSB (19.3 Mbps). For transmission over telephony systems, the compressed and encoded signals are preferably output in Digital Signal 3 (DS-3) format, Digital High-Speed Expansion Interface (DHEI) format, or any other conventional format. In some transmission systems, for example fiber optic, these RF modulation schemes are unnecessary as the transmission is purely digital.

Once modulated, the transport stream is output to the transmitter 528 for transmission over one of the many NTSC channels in the transmission broadcast 532. The transmitter 528 may transmit the transmission broadcast 532 over any conventional medium for transmitting digital data packets including, but not limited to broadcast television, cable television, satellite, DBS, fiber optic, microwave (e.g., a Multi-point Multi-channel Distribution System (MMDS)), radio, telephony, wireless telephony, digital subscriber line (DSL), personal communication system (PCS) networks, the Internet, public networks, and private networks, or any other transmission means. Transmission over communication networks may be accomplished by using any know protocol, for example, RTP, UDP, TCP/IP, and ATM. The transmission system may also be a telephone system transmitting a digital data stream. Thus, a multiplexed data stream containing several channels including the targeted programming components with related programming signals may be sent directly to a user's receiving system 304 over a single telephone line. The aforementioned digital transmission systems may include and utilize systems that transmit analog signals as well. It should be appreciated that various systems, mediums, protocols, and waveforms may be utilized in conjunction with the systems and methodologies of the present invention. In the preferred embodiment, the transmission broadcast 532 is distributed to remote user sites via cable, DBS, or other addressable transmission mediums.

In narrow bandwidth transmission systems, for example, cellular/wireless telephony and personal communication networks, still frame pictures or graphics, for example compressed in JPEG format, may comprise the targeted advertising components. Such still pictures or graphics could be presented on communications devices such as personal digital assistants (e.g., Palm Pilot®), telephones, wireless telephones, telephony devices for the deaf, or other devices with a liquid crystal display or similar lower resolution display. Textual information or an audio message could accompany the still frame images. Similarly, all-audio targeted programming options of CD quality sound, or less, could be provided via a digital radio transmission system.

A receiver 650, preferably consisting of the elements shown in FIG. 6, is preferably located at each user's reception site. The transmission broadcast 532 is received via a tuner/demodulator 662. The tuner/demodulator 662 may be a wide band tuner, in the case of satellite distribution, a narrow band tuner for standard NTSC signals, or two or more tuners for switching between different signals located in different frequency channels. The tuner/demodulator 662 tunes to the particular NTSC channel at the direction of the processor 660. The processor 660 may be a Motorola 68331 processor, or any conventional processor including PowerPC®, Intel Pentium®, MIPS, and SPARC® processors. The tuned channel is then demodulated by the tuner/demodulator 662 to strip the transport stream 200 (as depicted in FIG. 2) from the carrier frequency of the desired channel in the transmission broadcast 532.

The demodulated transport stream 200 is then forwarded to the demux/decoder 672. At the demux/decoder 672, the digital programming signals are demultiplexed and decompressed. Preferably, each incoming data packet in the transport stream 200 has its own PID. The demux/decoder 672 strips off the PID for each packet and sends the PID information to the processor 660. The processor 660, at the direction of the system software stored in memory 552, identifies the next appropriate packet to select for presentation to the user by comparing the PIDs to selection information or other criteria. The demux/decoder 672 then reconstitutes the selected digital programming signals from their packetized form and routes them to the appropriate digital-to-analog decoder, whether video, audio, graphic, or other.

Switches between and among regular programming and the targeted programming components preferably occur seamlessly using encoded video splice points as described in U.S. Pat. Nos. 5,724,091; 6,181,334; 6,204,843; 6215,484 and U.S. patent application Ser. Nos. 09/154,069; 09/335,372; and 09/429,850. The switch occurs in the demux/decoder 672 by switching to one or more packets comprising different targeted programming components in the transport stream 200. Upon receipt of the switching routine instructions from the processor 660, the demux/decoder 672 seeks the designated MPEG packet by its PID. Rather than selecting the data packet identified by the next serialized PID in the present service pipe (for example, packets comprising programming component pairs 204a in service pipe 202a in FIG. 2), the demux/decoder 672 may choose a synchronous packet by its PID from any service pipe in the transport stream 200 (for example, one or more of the programming components 206 in service pipe 202b of FIG. 2). In alternative embodiments, depending upon the hardware used, the switch can be entirely controlled by the demux/decoder 672, if for example the demux/decoder 672 is constructed with a register to store PID information for switching.

The processor's 660 selection may be based upon user information from the user profile system 306 (FIG. 3), producer directions or other commands sent from the transmission system 530 as data codes in the transport stream 200, and/or user input through the user interface 658 at the receiver 650. The user input, directions and commands, and user information may be stored in memory 652 for processing by the processor 660 according to routines within system software, also stored in memory 652. The stored user information, prior user input, and received data commands when processed, direct the demux/decoder's 672 switch between and among data packets comprising appropriately targeted programming components without any additional input or response from the user.

The memory 652 is preferably ROM, which holds operating system software for the receiver 650, and is preferably backed up with flash-ROM to allow for the reception and storage of downloadable code and updates. In the preferred embodiment, the system software can access and control the hardware elements of the device. Further, new software applications may be downloaded to the receiver 650 via either the transport stream 200 or a backchannel communication link 670 from the transmission system 530. These applications can control the receiver 650 and redefine its functionality within the constraints of the hardware. Such control can be quite extensive, including control of a front-panel display, on-screen displays, input and output ports, the demux/decoder 672, the tuner/demodulator 662, the graphics chip 676, and the mapping of the user interface 658 functions.

An interactive programming system is preferably incorporated to provide additional functionality for provision of the targeted programming segments. Such a system is preferably implemented as a software application within the receiver 650 and is preferably located within ROM or flash-ROM memory 652. The interactive system software, however, could alternatively be located in any type of memory device including, for example, RAM, EPROM, EEPROM, and PROM. The interactive programming system preferably solicits information from the user by presenting interactive programming segments, which may provide questionnaires, interrogatories, programming selection options, and other user response sessions. The user responds to such queries through the user interface 658. A user may interact with the user interface 658 via an infrared or radio frequency remote control, a keyboard, touch screen technology, or even voice activation. The user information 654 collected can be used immediately to affect the programming selection presented to the user, stored in memory 652 for later use with other programming selection needs, including the targeting programming component selection of the present invention, or incorporated into the user profile system 506.

The receiver 650 also preferably includes a backchannel encoder/modulator 668 (hereinafter, “backchannel 668”) for transmission of data to the transmission system 530 or to the user profile system 306 over the backchannel communication link 670. Data transmitted over the backchannel communication link 670 may include user information 654 collected at the receiver 650 or even direct user input, including interactive selections, made via the user interface 658. As previously noted, the backchannel 668 can also receive data from the transmission system via backchannel communication link 670, including software updates and user information 654 from the user profile system 306. The backchannel communication link 670 may by any appropriate communication system such as two-way cable television, personal satellite uplink, telephony, T-1 upstream, digital subscriber line, wireless telephony, or FM transmission.

Reconstructed video components are output from the demux/decoder 672 to video digital-to-analog (“D/A”) converter 688 for conversion from digital-to-analog signals for final output to the presentation device 318. Such D/A conversion may not be necessary if the presentation device 318 is also a digital device. An attached presentation device 318 may comprise a television, including high definition television, where the monitor may comprise a tube, plasma, liquid crystal, and other comparable display systems. In other embodiments of the invention, the presentation device 318 may be, for example, a personal computer system, a personal digital assistant, a cellular or wireless PCS handset, a telephone, a telephone answering device, a telephony device for the deaf, a web pad, a video game console, and a radio.

Graphics components are preferably output from the demux/decoder 672 to a graphics chip 676 to transform the graphics to a video format. The graphics components are then prepared for output to the presentation device 318 in the video D/A converter 688. Video and graphics components (as well as audio and other components) may also be temporarily stored in memory 652, or in a buffer (not shown), for rate control of the presentation or other delay need (for example to store graphic overlays for repeated presentation), prior to analog conversion by video D/A converter 688.

The associated digital audio programming components are decoded by demux/decoder 672 and preferably sent to a digital audio processor 680. The digital audio programming components are finally transformed back into analog audio signals by audio D/A converter 675 for output to the presentation device 318. The digital audio processor 680 is preferably a Dolby® digital processing integrated chip for the provision of, for example, surround sound, which includes an audio D/A converter 675. Data codes are also separated from the transport stream 200 by the demux/decoder 672 and are conducted to the processor 660 for processing of data commands.

In order to provide targeted programming utilizing the bandwidth tradeoff techniques disclosed herein, it is preferable to utilize the techniques in conjunction with a system that provides information about the users in order to more accurately target advertisements or other desired programming. Such information could be as simple as geographic location, which may also provide some demographic overtones. It is preferable, however, to have as much information as possible about users in order to target programming as accurately as possible. In the advertising context, increased accuracy in targeting translates into increased efficiency per dollar spent and, hopefully, increased returns. Addressable transmission systems such as digital cable and digital broadcast satellite television provide the ability to identify, interact with, and provide particular programming (e.g., pay-per-view-programming) directly to individual users, as well as collect more extensive information about them. Such information can include television viewing preferences, and more particularized geographic and demographic data. If the transmission system is interactive, queries can be presented to users to solicit additional user information, which can be compiled and analyzed to provide more focused programming content. Further, if the user participates in any television/Internet convergence programming offerings, additional information about the user's Internet usage can be used to establish a profile for the user, or profiles of groups of users, to allow the presentation of more targeted advertising and other programming.

In the preferred embodiment shown in FIG. 3, a user profile system 306 collects and tracks user information (reference numeral 526 in FIG. 5 in a transmission system 530, and reference numeral 654 in FIG. 6 in a receiver 650) within an interactive programming system 300. Preferably, the user profile system contains algorithms, as known in the art, for selecting, aggregating, filtering, messaging, correlating, and reporting statistics on groups of users. A detailed description of a preferred user profile system 306 embodiment is disclosed in U.S. patent application Ser. No. 09/409,035 entitled Enhanced Video Programming System and Method Utilizing User-Profile Information, which is hereby incorporated herein by reference. In general, however, the transmission system 302, reception system 304, and user profile system 306 are all interconnected via a communication system, preferably the Internet 322.

A user's profile may contain a wide variety of information concerning user characteristics for use in determining content to push to a user. As further explained below, the content may include any type of information such as video, audio, graphics, text, and multimedia content. Examples of content to be selectively pushed to the user based upon the user profile information 526, 654 include, but are not limited to, the following: targeted advertisements (as described herein), player profiles for sporting events, music or other audio information, icons representing particular services, surveys, news stories, and program suggestions. Through an interactive survey, for example by utilizing the user interface device 320, the interactive programming system 300 can dynamically modify and update a user's profile to further fine-tune the process of selecting particular content to push to the user based upon the user's donut. In the targeted advertising context, the answers to survey questions may be used to provide a second level of information within an advertisement pushed to a particular user. The interactive programming system 300 may use demographic data in a user's profile, for example, to determine which advertisement, among the multiplicity of related advertisements in the transport stream, to target to the user. The user's answers to questions in the survey may be used to push additional targeted advertisements to the user or additional content related to the advertisement previously pushed.

The receiving system 304 and/or transmission system 302 also monitor the user's activity in order to dynamically update the user's profile. The user's activity may involve any type of information relating to the user's interaction with the network or program content provided to the user. For example, the receiving system 304 may detect the following: programming viewed by the user; user viewing habits; advertisements viewed or not viewed; the rate at which the user selects or “clicks on” URLs to request particular content; which URLs the user selects; the amount of elapsed time the user has remained logged onto the network; the extent to which the user participates in chat room discussions; responses to interactive segments; other input from the user; and any other such information.

The determination of whether to update the user's profile may be based upon particular criteria related to the user's activity. For example, the receiving system 304 may store particular types of activity or thresholds for activity for comparison to the user's monitored activity, providing for an update when the user's activity matches the particular types of activity or exceeds the thresholds. It may also be updated based upon survey questions. If it is determined, based on the criteria, that the user's profile is to be updated, the receiving system 304 may dynamically update the user's profile based on the user's activity, save the updates, and optionally sends the updates to the transmission system 302 or other storage location for the user profile system 506.

Although various embodiments of this invention have been described above with a certain degree of particularity, or with reference to one or more preferred embodiments, those skilled in the art could make numerous alterations to the disclosed embodiments without departing from the spirit or scope of this invention. It is intended that all matter contained in the above description and shown in the accompanying drawings shall be interpreted as illustrative only and not limiting. Changes in detail or structure may be made without departing from the spirit and scope of the invention as defined in the following claims.

What is claimed is:

1. A method of increasing a quantity of differentiable programming content available in a digital programming transmission stream comprising:
creating a plurality of digital programming components, the plurality of digital programming components utilizing a bandwidth of the digital programming transmission stream less than or equal to a bandwidth normally allocated for a standard digital programming segment, wherein the standard digital programming segment is a unit of differentiable programming content;
defining at least one subset of the plurality of digital programming components to comprise at least one component programming segment, wherein the at least one component programming segment is also a unit of differentiable programming content; and
inserting at least the at least one subset of the plurality of digital programming components into the digital programming transmission stream;
wherein, without increasing the bandwidth normally allocated for a standard digital programming segment, the quantity of differentiable programming content available in the digital programming transmission stream is able to be increased by the number of units of differentiable programming content corresponding to the at least one component programming segment.

2. A method of providing an increased quantity of differentiable programming content in a programming transmission system, the differentiable programming content transmitted via a digital programming transmission stream, to a plurality of users, the method comprising:
synchronizing a plurality of digital programming components, the plurality of digital programming components utilizing a bandwidth of the digital programming transmission stream less than or equal to a bandwidth normally allocated for a standard digital programming segment, wherein the standard digital programming segment is a unit of differentiable programming content;
defining at least one subset of the plurality of digital programming components to comprise at least one component programming segment, wherein the at least one component programming segment is also a unit of differentiable programming content;
inserting the at least one subset of digital programming components into the digital programming transmission stream; and
transmitting the digital programming transmission stream to the plurality of users;
wherein, without increasing the bandwidth normally allocated for a standard digital programming segment, the quantity of differentiable programming content transmitted in the digital programming transmission stream is able to be increased by the number of units of differentiable programming content corresponding to the at least one component programming segment.

3. A method of receiving an increased quantity of differentiable programming content in a programming transmission system, the differentiable programming content received by at least one user via a digital programming transmission stream, the method comprising:
receiving a plurality of synchronized digital programming components in the digital programming transmission stream, the plurality of digital programming components utilizing a bandwidth of the digital programming transmission stream less than or equal to a bandwidth normally allocated for a standard digital programming segment, wherein the standard digital programming segment is a unit of differentiable programming content; and
selecting for presentation at least one subset of the plurality of digital programming components, the at least one subset comprising at least one component programming segment, wherein the at least one component programming segment is also a unit of differentiable programming content;
wherein, without increasing the bandwidth normally allocated for a standard digital programming segment, the quantity of differentiable programming content received in the digital programming transmission stream is able to be increased by the number of units of differentiable programming content corresponding to the at least one component programming segment.

4. A method for creating differentiable programming content, wherein a quantity of differentiable programming content available for transmission in a digital programming transmission stream is increased, the method comprising:
creating a plurality of digital programming components, the plurality of digital programming components utilizing a bandwidth of the digital programming transmission stream less than or equal to a bandwidth normally allocated for a standard digital programming segment, wherein the standard digital programming segment is a unit of differentiable programming content;
synchronizing the plurality of digital programming components; and
defining at least one subset of the plurality of digital programming components to comprise at least one component programming segment, wherein the at least one component programming segment is also a unit of differentiable programming content;
wherein, without increasing the bandwidth normally allocated for a standard digital programming segment, the quantity of differentiable programming content available for transmission in the digital programming transmission stream is able to be increased by the number of units of differentiable programming content corresponding to the at least one component programming segment.

5. A method as described in claim 1 further comprising inserting the plurality of digital programming components into the digital programming transmission stream.

6. A method as described in claim 1 or claim 2 wherein the at least one subset of the plurality of digital programming components replaces the standard digital programming segment in the digital programming transmission stream.

7. A method as described in claim 1 or claim 2 wherein the at least one subset of the plurality of digital programming components is inserted into the digital programming transmission stream in addition to the standard digital programming segment.

8. A method as described in claim 5 wherein the plurality of digital programming components replaces the standard digital programming segment in the digital programming transmission stream.

9. A method as described in claim 5 wherein the plurality of digital programming components is inserted into the digital programming transmission stream in addition to the standard digital programming segment.

10. A method as described in claim 7 wherein the standard digital programming segment is reduced in quality and therefore utilizes less than the bandwidth normally allocated for a standard digital programming segment.

11. A method as described in claim 9 wherein the standard digital programming segment is reduced in quality and therefore utilizes less than the bandwidth normally allocated for a standard digital programming segment.

12. A method as described in claim 3 wherein the plurality of digital programming components replaces the standard digital programming segment in the digital programming transmission stream.

13. A method as described in claim 3 wherein the plurality of digital programming components is received in the digital programming transmission stream in addition to the standard digital programming segment.

14. A method as described in claim 13 wherein the standard digital programming segment is reduced in quality and therefore utilizes less than the bandwidth normally allocated for a standard digital programming segment.

15. A method as described in claim 1, claim 2, claim 3, or claim 4 wherein the plurality of digital programming components are selected from the group consisting of: video, still-frame video, audio, graphics, text, animation, and media objects.

16. A method as described in claim 15 wherein the still-frame video comprises scalable video frames.

17. A method as described in claim 15 wherein the audio comprises less than CD-quality audio.

18. A method as described in claim 1, claim 2, or claim 4 further comprising digitally compressing the plurality of digital programming components.

19. A method as described in claim 3 further comprising digitally decompressing the plurality of digital programming components.

20. A method as described in claim 1 wherein the digital programming transmission stream is carried over a transmission medium selected from the group consisting of: terrestrial television broadcast, cable, satellite, microwave, radio, telephony, wireless telephony, digital subscriber line, fiber optic, a personal communications network, and a communication network.

21. A method as described in claim 2 wherein the digital programming transmission stream is transmitted over a transmission medium selected from the group consisting of: terrestrial television broadcast, cable, satellite, microwave, radio, telephony, wireless telephony, digital subscriber line, fiber optic, a personal communications network, and a communication network.

22. A method as described in claim 3 wherein the digital programming transmission stream is received over a transmission medium selected from the group consisting of: terrestrial television broadcast, cable, satellite, microwave, radio, telephony, wireless telephony, digital subscriber line, fiber optic, a personal communications network, and a communication network.

23. A method as described in claim 20, claim 21, or claim 22 wherein the communication network is selected from the group consisting of: the Internet, an intranet, a local area network, a wide area network, a public network, and a private network.

24. A method as described in claim 1, claim 2, claim 3, or claim 4 wherein the differentiable programming content comprises advertising programming content.

25. A method as described in claim 1, claim 2, claim 3, or claim 4 wherein the differentiable programming content comprises programming content selected from the group consisting of: news, sports, entertainment, situation comedy, music video, game show, movie, drama, educational programming, interactive video gaming, and live programming.

26. A method as described in claim 1 further comprising synchronizing the plurality of digital programming components.

27. A method as described in claim 1 further comprising targeting the at least one component programming segment toward at least one of a plurality of users receiving the digital programming transmission stream.

28. A method as described in claim 2 further comprising targeting the at least one component programming segment toward at least one of the plurality of users to provide particular differentiable programming content to the at least one of the plurality of users.

29. A method as described in claim 28 wherein the at least one component programming segment is targeted toward the at least one of the plurality of users based upon user profile information of the at least one of the plurality of users accessible by the programming transmission system.

30. A method as described in claim 3 further comprising determining whether the at least one component programming segment is targeted toward the at least one user to provide particular differentiable programming content to the at least one user, and wherein the step of selecting is based upon a determination that the at least one component programming segment is targeted toward the at least one user.

31. A method as described in claim 30 further comprising accessing user profile information of the at least one user to determine whether the at least one component programming segment is targeted toward the at least one user based upon the user profile information of the at least one user.

32. A method as described in claim 3 further comprising outputting the at least one component programming segment to a presentation device for presentation to the at least one user.

33. A method as described in claim 3 further comprising switching from a first of the at least one component programming segment to a second of the at least one component programming segment.

34. A method as described in claim 33 further comprising outputting the first and second of the at least one component programming segment in sequence to a presentation device for presentation to the at least one user, and wherein the step of switching is seamless, whereby the switch is performed without a delay perceptible by the at least one user between presentation of the first of the at least one component programming segment and presentation of the second of the at least one component programming segment on the presentation device.

35. A method as described in claim 32 or claim 34 wherein the presentation device comprises a device selected from the group consisting of: television, radio, video tape player, audio tape player, digital video disk player, compact digital disk player, minidisk player, digital file player, video game player, computer, personal digital assistant device, telephone, wireless telephone, and a telephony device for the deaf.

36. A system for providing an increased quantity of differentiable programming content in a programming transmission system, the differentiable programming content transmitted via a digital programming transmission stream, to a plurality of users, the system comprising:
an encoder that interleaves a plurality of synchronized digital programming components, wherein at least one subset of the plurality of digital programming components comprises at least one component programming segment, and the at least one component programming segment is a unit of differentiable programming content; and
a transmitter that transmits the plurality of digital programming components in the digital programming transmission stream to the plurality of users, the plurality of digital programming components utilizing a bandwidth of the digital programming transmission stream less than or equal to a bandwidth normally allocated for a standard digital programming segment, wherein the standard digital programming segment is also a unit of differentiable programming content;
wherein, without increasing the bandwidth normally allocated for a standard digital programming segment, the quantity of differentiable programming content transmitted in the digital programming transmission stream by the transmitter is able to be increased by the number of units of differentiable programming content corresponding to the at least one component programming segment.

37. A system for receiving an increased quantity of differentiable programming content in a programming transmission system, the differentiable programming content received by at least one user via a digital programming transmission stream, the system comprising:
a tuner that receives a plurality of synchronized digital programming components in the digital programming transmission stream, the plurality of digital programming components utilizing a bandwidth of the digital programming transmission stream less than or equal to a bandwidth normally allocated for a standard digital programming segment, wherein the standard digital programming segment is a unit of differentiable programming content;
a decoder that separates and selects at least one subset of the plurality of digital programming components, the at least one subset comprising at least on component programming segment, wherein the at least one component programming segment is also a unity of differentiable programming content;
a program output that outputs the at least one component programming segment to a presentation device for presentation of the at least one component programming segment to the at least one user; and
a processor that coordinates and directs the functions of the tuner, the decoder, and the program output;
wherein, without increasing the bandwidth normally allocated for a standard digital programming segment, the quantity of differentiable programming content in the digital programming transmission stream received by the receiver is able to be increased by the number of units of differentiable programming content corresponding to the at least one component programming segment.

38. A system for providing an increased quantity of differentiable programming content in a programming transmission system, the differentiable programming content transmitted via a digital programming transmission stream, to a plurality of users, the system comprising:
a means for combining a plurality of synchronized digital programming components, wherein at least one subset of the plurality of digital programming components comprises at least one component programming segment, and the at least one component programming segment is a unit of differentiable programming content; and
a means for transmitting the plurality of digital programming components in the digital programming transmission stream to the plurality of users, the plurality of digital programming components utilizing a bandwidth of the digital programming transmission stream less than or equal to a bandwidth normally allocated for a standard digital programming segment, wherein the standard digital programming segment is also a unit of differentiable programming content;
wherein, without increasing the bandwidth normally allocated for a standard digital programming segment, the quantity of differentiable programming content transmitted in the digital programming transmission stream by the transmitting means is able to be increased by the number of units of differentiable programming content corresponding to the at least one component programming segment.

39. A system for receiving an increased quantity of differentiable programming content in a programming transmission system, the differentiable programming content received by at least one user via a digital programming transmission stream, the system comprising:
a means for receiving a plurality of synchronized digital programming components in the digital programming transmission stream, the plurality of digital programming components utilizing a bandwidth of the digital programming transmission stream less than or equal to a bandwidth normally allocated for a standard digital programming segment, wherein the standard digital programming segment is a unit of differentiable programming content;
a means for selecting at least one subset of the plurality of digital programming components, the at least one subset comprising at least on component programming segment, wherein the at least one component programming segment is also a unity of differentiable programming content;
a means for outputting the at least one component programming segment to a means for presenting the at least one component programming segment to the at least one user; and
a means for processing that coordinates and directs the functions of the receiving means, the selecting means, and the outputting means;
wherein, without increasing the bandwidth normally allocated for a standard digital programming segment, the quantity of differentiable programming content in the digital programming transmission stream received by the receiving means is able to be increased by the number of units of differentiable programming content corresponding to the at least one component programming segment.

40. A system as described in claim 36 wherein the transmitter transmits the plurality of digital programming components in place of the standard digital programming segment in the digital programming transmission stream.

41. A system as described in claim 38 wherein the transmitting means transmits the plurality of digital programming components in place of the standard digital programming segment in the digital programming transmission stream.

42. A system as described in claim 36 wherein the transmitter transmits the plurality of digital programming components in the digital programming transmission stream in addition to the standard digital programming segment.

43. A system as described in claim 38 wherein the transmitting means transmits the plurality of digital programming components in the digital programming transmission stream in addition to the standard digital programming segment.

44. A system as described in claim 37 wherein the receiver receives the plurality of digital programming components in the digital programming transmission stream in place of the standard digital programming segment.

45. A system as described in claim 39 wherein the receiving means receives the plurality of digital programming components in the digital programming transmission stream in place of the standard digital programming segment.

46. A system as described in claim 37 wherein the receiver receives the plurality of digital programming components in the digital programming transmission stream in addition to the standard digital programming segment.

47. A system as described in claim 39 wherein the receiving means receives the plurality of digital programming components in the digital programming transmission stream in addition to the standard digital programming segment.

48. A system as described in claim 42, claim 43, claim 46, or claim 47 wherein the standard digital programming segment is reduced in quality and therefore utilizes less than the bandwidth normally allocated for a standard digital programming segment.

49. A system as described in claim 36, claim 37, claim 38, or claim 39 wherein the plurality of digital programming components are selected from the group consisting of: video, still-frame video, audio, graphics, text, animation, and media objects.

50. A system as described in claim 49 wherein the still-frame video comprises scalable video frames.

51. A system as described in claim 49 wherein the audio comprises less than CD-quality audio.

52. A system as described in claim 36 further comprising a digital compressor that compresses the plurality of digital programming components before they reach the multiplexer.

53. A system as described in claim 38 further comprising a means for digitall compressing the plurality of digital programming components before they reach the combining means.

54. A system as described in claim 37 further comprising a digital decompressor that decompresses the plurality of digital programming components, and wherein the processor further coordinates and directs the function of the decompressor.

55. A system as described in claim 39 further comprising means for digitally decompressing the plurality of digital programming components, and wherein the processing means further coordinates and directs the function of the decompressing means.

56. A system as described in claim 36 further comprising a synchronization component that synchronizes the plurality of digital programming components before they reach the multiplexer.

57. A system as described in claim 38 further comprising a means for synchronizing the plurality of digital programming components before they reach the combining means.

58. A system as described in claim 36 further comprising a modulator that modulates the multiplexed digital programming components before they reach the transmitter.

59. A system as described in claim 38 further comprising a means for modulating the combined digital programming components before they reach the transmitting means.

60. A system as described in claim 36 further comprising a memory for storing the plurality of digital programming components before they reach the multiplexer.

61. A system as described in claim 38 further comprising a means for storing the plurality of digital programming components before they reach the combining means.

62. A system as described in claim 36 further comprising a memory that stores user profile information of the at least one of the plurality of users, wherein the processor further coordinates and directs the function of the memory, and wherein the at least one component programming segment is targeted to the at least one of the plurality of users based upon the user profile information of the at least one of the plurality of users, to provide particular differentiable programming content to the at least one of the plurality of users.

63. A system as described in claim 37 wherein the at least one component programming segment is targeted toward the at least one user to provide particular differentiable programming content to the at least one user, and wherein the signal selector further selects the at least one component programming segment based upon information in the at least one subset of the plurality of digital programming components that the at least one component programming segment is targeted to the at least one user.

64. A system as described in claim 63 further comprising a memory for storing user profile information of the at least one user, wherein the signal selector further selects the at least one component programming segment that is targeted to the at least one user based upon the user profile information of the at least one user.

65. A system as described in claim 36 wherein transmitter transmits the digital programming transmission stream over a transmission medium selected from the group consisting of: terrestrial television broadcast, cable, satellite, microwave, radio, telephony, wireless telephony, digital subscriber line, fiber optic, a personal communications network, and a communication network.

66. A system as described in claim 37 wherein the receiver receives the digital programming transmission stream over a transmission medium selected from the group consisting of: terrestrial television broadcast, cable, satellite, microwave, radio, telephony, wireless telephony, digital subscriber line, fiber optic, a personal communications network, and a communication network.

67. A system as described in claim 65 or claim 66 wherein the communication network is selected from the group consisting of: the Internet, an intranet, a local area network, a wide area network, a public network, and a private network.

68. A system as described in claim 66 further comprising a network connector that provides a connection with the communication network for receiving the plurality of digital programming components from the communication network.

69. A system as described in claim 39 further comprising a means for connecting the receiving means with a communication network, wherein the plurality of digital programming components are received over the communication network.

70. A system as described in claim 36 or claim 37 wherein the differentiable programming content comprises advertising programming content.

71. A system as described in claim 36 or claim 37 wherein the differentiable programming content comprises programming content selected from the group consisting of: news, sports, entertainment, situation comedy, music video, game show, movie, drama, educational programming, interactive video gaming, and live programming.

72. A system as described in claim 37 further comprising a signal switcher that switches from a first of the at least one component programming segment to a second of the at least one component programming segment, and wherein the processor further coordinates and directs the function of the signal switcher.

73. A system as described in claim 72 wherein the switch by the signal switcher is seamless, whereby the switch is performed without a delay perceptible by the at least one user between presentation of the first of the at least one component programming segment and presentation of the second of the at least one component programming segment on the presentation device.

74. A system as described in claim 37 wherein the presentation device comprises a device selected from the group consisting of: television, radio, video tape player, audio tape player, digital video disk player, compact digital disk player, minidisk player, digital file player, video game player, computer, personal digital assistant device, telephone, wireless telephone, and a telephony device for the deaf

75. A computer program product for instructing a computer controlled digital programming reception system with interactive programming technology to select targeted differentiable programming content for a user, the targeted differentiable programming content received at the reception system via a digital programming transmission stream in an increased quantity, the computer program product comprising a computer readable medium having computer readable program code embodied therein for controlling the programming reception system, the computer readable program code comprising instructions for:
causing the programming reception system to determine whether a plurality of synchronized digital programming components received in the digital programming transmission stream comprises targeted differentiable programming content, wherein the plurality of digital programming components utilize a bandwidth of the digital programming transmission stream less than or equal to a bandwidth normally allocated for a standard digital programming segment, wherein the standard digital programming segment is a unit of differentiable programming content;
causing the programming reception system to access information in a user profile about the user;
causing the programming reception system to select at least one subset of the plurality of digital programming components, the at least one subset comprising at least one component programming segment; wherein the at least one component programming segment is also a unit of differentiable programming content; wherein, without increasing the bandwidth normally allocated for a standard digital programming segment, the quantity of differentiable programming content received in the digital programming transmission stream is able to be increased by the number of units of differentiable programming content corresponding to the at least one component programming segment; and wherein the selection of the at least one subset of the plurality of component programming segments is determined by the programming reception system based upon the user profile information of the user to provide targeted differentiable programming content to the user; and
causing the programming reception system to output the at least one component programming segment for presentation to the user on a presentation device.

76. A computer program product as described in claim 75 wherein the computer readable program code further comprises instructions for:
causing the programming reception system to identify a splice point in a first of the at least one component programming segment before the completion of its presentation to the user;
causing the programming reception system to select a second of the at least one component-programming segment, wherein the selection of the second of the at least one component programming segment is determined by the programming reception system based upon the user profile information of the user;
causing the programming reception system to seamlessly switch from the first at least one of the component programming segment to the second at least one component programming segment at the splice point identified in the first at least one component programming segment; and
causing the programming reception system to output the second at least one component programming segment for presentation to the user on the presentation device;
wherein the switch is accomplished without a delay perceptible by the user between the presentation of the first at least one component programming segment and the presentation of the second at least one component programming segment on the presentation device.

77. A method of receiving an increased quantity of differentiable advertising segments in a programming transmission system, the differentiable advertising segments received by at least one user via a digital programming transmission stream, the method comprising:
receiving a plurality of synchronized digital programming components in the digital programming transmission stream, the plurality of digital programming components utilizing a bandwidth of the digital programming transmission stream less than or equal to a bandwidth normally allocated for a full-motion audio-video segment, wherein the full motion audio-video segment is a unit of differentiable programming content; and
selecting for presentation at least one subset of the plurality of digital programming components, the selection performed by a processor implementing at least one command code, the selection based upon packet identification numbers of a plurality of packets comprising the at least one subset, the at least one subset comprising at least one advertising segment, wherein the at least one advertising segment is also a unit of differentiable programming content;
wherein, without increasing the bandwidth normally allocated for a full motion audio-video segment, the quantity of differentiable advertising segments received in the digital programming transmission stream is able to be increased by the number of units of differentiable programming content corresponding to the at least one advertising segment.

78. A method as described in claim 77 wherein the plurality of digital programming components are selected from the group consisting of: video, still-frame video, audio, graphics, text, animation, and media objects.

79. A method as described in claim 77 wherein the step of receiving further comprises receiving the at least one command code in the digital programming transmission stream.

80. A method as described in claim 77 further comprising receiving the at least one command code from a user via a user interface.
